(19) United States
(12) Patent Application Publication
(10) Pub. No.: US 2026/0274148 A1
(43) Pub. Date: Sep. 17, 2026

(54) TRAILERS AND TRUCKS HAVING EXPANDABLE CARGO COMPARTMENTS, AND COVERING SYSTEMS AND OUTRIGGERS THEREFOR

(71) Applicants: Darryl Clive Metz, Miami, FL (US); Cherise Mandy Metz, Miami, FL (US)

(72) Inventors: Darryl Clive Metz, Miami, FL (US); Cherise Mandy Metz, Miami, FL (US)

(21) Appl. No.: 19/077,338

(22) Filed: Mar. 12, 2025

(51) Int. Cl. B60P 3/34; B60S 9/04

(52) U.S. Cl. CPC B60P 3/343; B60S 9/04

(57) ABSTRACT

Trailers and trucks, for hauling cargo, which also have (i) retractable compartments or platforms for use as modern, rapidly deployable sleeping quarters, offices, administrative facilities, medical facilities, command centers, kitchens, canteens, etc. and (ii) covering systems which protect and change or improve the appearance of the expandable trailers and trucks, screen the expandable trailers and trucks from sunlight or from view, and provide additional insulation from wind and cold.

### FIELD OF THE INVENTION

The present invention relates to trailers and trucks having cargo compartments which are expandable for use as rapidly deployable sleeping quarters, offices, administrative facilities, medical facilities, command centers, kitchens, or canteens, as well as for other purposes. In another aspect, the invention relates to covering systems which (i) protect, and change or improve the appearance of, expandable trailers and trucks, (ii) screen the expandable trailers and trucks from sunlight or from view, and (iii) provide additional insulation from wind and cold.

### BACKGROUND OF THE INVENTION

In the face of natural disasters and other large scale emergency situations, a need exits for rapidly deployable trailer and truck systems which, in addition to hauling food, water, equipment, and other critical cargo to the disaster or emergency site, can also be used for additional purposes of vital importance. A need particularly exists for trailers and trucks having cargo compartments which can be quickly expanded and converted for use as modern, equipped sleeping, administrative, command, medical, office, canteen, kitchen, and other facilities, and which can also include bathrooms, climate controls, kitchenettes, and other features.

As just one example, as of June 2024, the UN Refugee Agency estimates 122.6 million people around the world have been forced to flee their homes. The use of traditional tents to humanely house these people has proven to be inadequate for several reasons. Tents lack privacy and fail to provide adequate protection against extreme weather conditions, ground water, mud, sand and dust. Tents also (i) lack durability, take time and are difficult to assemble and are easily damaged, (ii) are not equipped for delivering essential water, electrical, and other services and utilities, and (iii) do not provide sufficient protection, safety, and security against theft and other crimes.

A need also exists for covering systems which can be used on expandable trailers and trucks to: (i) provide a more tent-like, rustic, or other appearance which makes the expanded trailer or truck more attractive; (ii) cause the expanded trailer or truck to blend-in to a greater degree with the natural surroundings; (iii) screen the expanded trailer or truck from sunlight to provide shade and protect the trailer or truck from sun damage; (iv) screen the expanded trailer or truck to at least some degree from view or detection; and (v) provide additional insulation from wind and cold. The covering systems will also preferably be quick and easy to assemble and disassemble and readily stowable in compact form for transport.

### SUMMARY OF THE INVENTION

The present invention provides expandable trailers and trucks, and covering systems therefor, that satisfy the needs and alleviate the problems discussed above. The expandable trailers and trucks provided by the present invention are rapidly deployable and readily customizable for addressing these problems and needs. The inventive trailer and truck systems provide expandable shelters which are adaptable for all manner of different uses and operations. Unlike traditional tents, the inventive shelters do not have to be transported separately as additional cargo.

Moreover, the inventive, expandable shelters are (i) comfortable and accommodating, (ii) spaced above ground to provide protection against water, mud, sand, and dust, (iii) designed for extreme weather conditions, (iv) cost-effective for deployment, (v) very sturdy and highly durable, (vi) much safer and more secure, and (vi) re-deployable, at a moments notice, for repeated use.

The expandable shelters also provide greater privacy and can provide electrical and utility hookups, supports, etc. as needed for use, e.g., as modern sleeping, administrative, command, medical, office, canteen, kitchen, and other facilities. The expandable shelters can also include bathrooms, climate controls, personal storage lockers, kitchenettes, and other features. Plus, the interiors of the inventive trailers and trucks can be formed of composites or other materials which are light weight and easy to wash down and disinfect so that the inventive expandable shelters are far more sanitary than traditional tents.

As compared to traditional tents, the inventive trailer and truck shelter systems are also much easier and require much less manpower to open, set-up, breakdown, and re-deploy, thus saving significant time and expense.

In addition, the covering systems provided by present invention can be used to further enhance both the performance and appearance of the expandable shelters. The covering systems can be readily adapted to provide a more tent-like, rustic, or other appearance which (i) makes the expanded trailer or truck more attractive and (ii) blends-in to a greater degree with the natural surroundings. The inventive covering systems are also quick and easy to assemble and disassemble, convenient to store and transport, and can (a) screen the expanded trailer or truck from sunlight to provide shade, (b) protect the trailer or truck from sun damage, (c) screen the expanded trailer or truck to a desirable degree from view, observation, or detection, and (d) provide additional insulation from wind and cold.

The inventive expandable trailer and truck systems are also well suited for use as camping or glamping units, concert platforms, or for other recreational purposes. Moreover, such uses can be further enhanced by the inventive covering systems.

In one aspect, there is provided a trailer or truck which preferably comprises: (a) a cargo housing having a cargo compartment therein, a cargo bed which extends longitudinally in a bottom of the cargo housing, a roof spaced above the cargo bed, a first substantially vertical side which extends longitudinally between a rearward longitudinal end and a forward longitudinal end of the cargo housing, and a second substantially vertical side, opposite the first substantially vertical side, which extends longitudinally between the rearward longitudinal end and the forward longitudinal end; (b) a side opening, in at least the first substantially vertical side, having a longitudinal length which is at least half of a longitudinal distance measured from the rearward longitudinal end to the forward longitudinal end of the cargo housing; and (c) a tent compartment assembly.

The tent compartment assembly preferably comprises: (1) a side panel having a lower end which is pivotably connected to the cargo housing for pivoting the side panel from a raised (preferably vertical or substantially vertical) position, in which the side panel covers the side opening, to at least a lowered (preferably horizontal or substantially horizontal) position in which the side panel becomes a floor of the tent compartment assembly; (2) a collapsible tent having a bottom end which is attached to the side panel and an inner side which is connected to the cargo housing along at least most of a longitudinal top, at least most of a substantially vertical forward end, and at least most of a substantially vertical rearward end of the side opening of the cargo housing so that the side opening of the cargo housing is an entryway for the tent compartment assembly when the side panel is in the lowered position; (3) a tent wall frame which is pivotably attached to the side panel so that when the side panel is in the lowered position, the tent wall frame can be pivoted upwardly inside the collapsible tent to a raised position in which the tent wall frame raises and supports an outer (preferably substantially vertical) wall of the collapsible tent; and (4) a tent roof frame which is pivotably attached to the tent wall frame so that when the tent wall frame is pivoted upwardly to the raised position of the tent wall frame, the tent roof frame can be pivoted upwardly inside the collapsible tent to a raised position to raise and support a roof of the collapsible tent.

In another aspect, there is provided a trailer or truck which preferably comprises: (a) a cargo housing having a cargo compartment therein for hauling cargo, a cargo bed which extends longitudinally in a bottom the cargo housing, a roof spaced above the cargo bed, a first substantially vertical side which extends longitudinally between a rearward longitudinal end and a forward longitudinal end of the cargo housing, and a second substantially vertical side, opposite the first substantially vertical side, which extends longitudinally between the rearward longitudinal end and the forward longitudinal end; (b) each of the first and second substantially vertical sides having a side opening therein having a longitudinal length which is at least half of a longitudinal distance measured from the rearward longitudinal end to the forward longitudinal end of the cargo housing; and (c) the side opening of each of the first and second substantially vertical sides having a tent compartment assembly associated therewith.

The tent compartment assembly associated with the side opening of each of the first and second substantially vertical sides of the cargo housing preferably comprises: (1) a side panel having a lower end which is pivotably connected to the cargo housing for pivoting the side panel from a raised position, in which the side panel covers the side opening, to at least a lowered position in which the side panel becomes a floor of the tent compartment assembly; (2) a collapsible tent having a bottom end which is attached the side panel and an inner side which is connected to the cargo housing along at least most of a longitudinal top, at least most of a substantially vertical forward end, and at least most of a substantially vertical rearward end of the side opening of the cargo housing so that the side opening of the cargo housing is an entryway for the tent compartment assembly when the side panel is in the lowered position; (3) a tent wall frame which is pivotably attached to the side panel so that when the side panel is in the lowered position, the tent wall frame can be pivoted upwardly inside the collapsible tent to a raised position in which the tent wall frame raises and supports an outer wall of collapsible tent, wherein when the outer wall of the collapsible tent is raised, it is opposite the inner side of the collapsible tent; and (4) a tent roof frame which is pivotably attached to the tent wall frame so that when the tent wall frame is pivoted upwardly to the raised position of the tent wall frame, the tent roof frame can be pivoted upwardly inside the collapsible tent to a raised position to raise and support a roof of the collapsible tent.

In another aspect, there is provided a trailer or truck which preferably comprises: (a) a cargo housing having a roof on top of the cargo housing and a housing compartment within the cargo housing; (b) a plurality of first support structures which extend upwardly from the roof of the cargo housing; (c) a plurality of second support structures which extend upwardly from the roof of the cargo housing; (d) a plurality of outwardly extending covering support elements; and (e) a removable covering which is positioned over the first support structures, the second support structures, and the outwardly extending covering support elements so that the removable covering covers at least most of the roof of the cargo housing.

The second support structures of the trailer or truck are preferably (i) shorter than the first support structures and (ii) positioned between at least most of the first support structures and an outer perimeter of the roof of the cargo housing or are positioned on the outer perimeter of the roof of the cargo housing. Each of the outwardly extending covering support elements of the trailer or truck preferably (i) extends outwardly from an upper end or upper portion of one of the first support structures and (ii) slopes downwardly as it extends outwardly. At least most of the outwardly extending covering support elements are supported by one of the second support structures.

In another aspect, there is provided a trailer or truck which preferably comprises: (a) a cargo housing having a roof on top of the cargo housing and a housing compartment within the cargo housing; (b) a left retractable platform or retractable compartment which is extendable from a left lateral side of the cargo housing to a deployed position for use and is retractable to a retracted position for transporting the trailer or truck; (c) a right retractable platform or retractable compartment which is extendable from a right lateral side of the cargo housing to a deployed position for use and is retractable to a retracted position for transporting the trailer or truck; (d) a plurality of first support structures which extend upwardly from the roof of the cargo housing; (e) a plurality of second support structures which extend upwardly from the roof of the cargo housing; (f) a plurality of outwardly extending covering support frames; and (g) a removable covering which is positioned over the first support structures and the outwardly extending covering support frames.

The second support structures of the trailer or truck are preferably (i) shorter than the first support structures and (ii) positioned between at least most of the first support structures and an outer perimeter of the roof of the cargo housing or are positioned on the outer perimeter of the roof of the cargo housing. Each of the covering support frames preferably has an upper frame element which (i) extends outwardly from an upper end or upper portion of one of the first support structures and (ii) slopes downwardly as it extends outwardly. The upper frame element of at least most of the outwardly extending covering support frames is supported by one of the second support structures.

When the left retractable platform or retractable compartment and the right retractable platform or retractable compartment of the trailer or truck are in their deployed positions and the removable covering is positioned over the first support structures and the outwardly extending covering support frames, the removable covering extends over at least most of the roof of the cargo housing, at least most of the top of the left retractable platform or retractable compartment, and at least most of the top of the right retractable platform or retractable compartment.

In another aspect, there is provided a trailer or truck which preferably comprises: (a) a cargo housing having a roof on top of the cargo housing and a housing compartment within the cargo housing; (b) a plurality of lateral channels positioned on the roof of the cargo housing which are spaced longitudinally apart; (c) a set of cover support frames; and (d) a removable covering. Each of the cover support frames in the set of cover support frames preferably comprises: (i) a first upwardly extending support structure having a lower end which is removably received and held in a supporting one of the lateral channels, (ii) a sloped upper frame element which extends laterally outward, at a downward inclination, from an upper end or upper portion of the first upwardly extending support structure, and (iii) a second upwardly extending support structure having an upper end which is attached at a mid-portion location of the sloped upper frame element and having a lower end which is removably received and held in the supporting one of the lateral channels, the first upwardly extending support structure being taller than the second upwardly extending support structure. The removable covering is positioned on, and supported over at least a portion of the roof of the cargo housing by, the set of cover support frames.

Each of the cover support frames of the set of cover support frames can also have a lower frame element which (i) has an outer end which is attached to the sloped upper frame element of the cover support frame at an outer location which is spaced outwardly from the mid-portion location at which the second upwardly extending support structure is attached to the sloped upper frame element and (ii) extends substantially horizontally from the outer location of the sloped upper frame element back toward the lower end of the second upwardly extending support structure.

Each of the cover support frames can also be foldable so that: (i) the upper end of the first upwardly extending support structure of the cover support frame is pivotably attached to the sloped upper frame element of the cover support frame; (ii) the first upwardly extending support structure of the cover support frame having a U-shaped channel in which the sloped upper frame element of the cover support frame is received when the first upwardly extending support structure is pivoted to a folded position; (iii) the upper end of the second upwardly extending support structure of the cover support frame is pivotably attached to the sloped upper frame element of the cover support frame; (iv) the second upwardly extending support structure of the cover support frame has a U-shaped channel in which the sloped upper frame element of the cover support frame is received when the second upwardly extending support structure is pivoted to a folded position; (v) the outer end of the lower frame element of the cover support frame is pivotably attached to the sloped upper frame element of the cover support frame; and (vi) the lower frame element of the cover support frame has a U-shaped channel in which the sloped upper frame element of the cover support frame is received when the lower frame element is pivoted to a folded position.

In another aspect, there is provided a trailer or truck which preferably comprises: (a) a cargo housing having a roof on top of the cargo housing and a housing compartment within the cargo housing; (b) a first lateral channel on the roof of the cargo housing; (c) a second lateral channel on the roof of the cargo housing, the second lateral channel being spaced longitudinally apart from the first lateral channel; (d) the first lateral channel and the second lateral channel each having a left cover support frame and a right cover support frame installed therein; and (e) a removable covering.

Each of the left and the right cover support frames installed in each of the first and the second lateral channels preferably comprises: (i) a first upwardly extending support structure having a lower end which is removably received and held in the lateral channel, (ii) a sloped upper frame element which extends laterally outward, at a downward inclination, from an upper end or upper portion of the first upwardly extending support structure, and (iii) a second upwardly extending support structure having an upper end which is attached at a mid-portion location of the sloped upper frame element and having a lower end which is removably received and held in the lateral channel, the first upwardly extending support structure being taller than the second upwardly extending support structure.

The sloped upper frame elements of the left cover support frames installed in the first and the second lateral channels preferably extend laterally outward over a left side of the roof of the cargo housing. The sloped upper frame elements of the right cover support frames installed in the first and the second lateral channels preferably extend laterally outward over a right side of the roof of the cargo housing. The removable covering is positioned on, and supported over at least a portion of the roof of the cargo housing by at least (i) the left and the right cover support frames installed in the first lateral channel and (ii) the left and the right cover support frames installed in the second lateral channel.

Each of the left and the right cover support frames installed in each of the first and the second lateral channels can also include a lower frame element which (i) has an outer end attached to the sloped upper frame element of the cover support frame at an outer location which is spaced outwardly from the mid-portion location at which the second upwardly extending support structure is attached to the sloped upper frame element and (ii) extends substantially horizontally from the outer location of the sloped upper frame element back toward the lower end of the second upwardly extending support structure. Each of the left and right cover support frames can also be a foldable cover support frame as described above.

In another aspect, there is provided a trailer or truck which preferably comprises: (a) a cargo housing having a roof on top of the cargo housing and a housing compartment within the cargo housing; (b) a retractable platform or retractable compartment which is extendable from a lateral side of the cargo housing to a deployed position for use and is retractable to a retracted position for transporting the trailer or truck; (c) a longitudinally extending solar panel structure that is pivotably secured on the roof of the cargo housing for pivoting the solar panel structure upwardly on the roof of the cargo housing to an upwardly angled operating position; (d) a set of removable canopy supports on the lateral side of the cargo housing; and (e) a removable covering.

Each of the removable canopy supports of the trailer or truck preferably comprises: (i) a first elongate support element that extends outwardly from the roof of the cargo housing, or from an upper portion the lateral side of the cargo housing, and (ii) a second elongate support element that extends downwardly from the distal end of the first elongate support element. The removable covering of the trailer or truck preferably comprises: a roof having (i) a longitudinally extending upper ridge, (ii) a first side which extends laterally outward from the upper ridge at a downward angle, at least most of a total area of the first side of the roof being an open area which is positioned over the solar panel structure to expose the solar panel structure to sunlight when the solar panel structure is oriented in its angled operating position, and (iii) a second side, opposite the first side of the roof, which extends outwardly from the upper ridge at a downward angle. The removable covering also preferably comprises a canopy which extends from a lower side edge of the roof of the removable covering over the first elongate support elements of the canopy supports so that the canopy is positioned over at least most of a top of the retractable platform or retractable compartment.

In another aspect, there is provided a trailer or truck which preferably comprises: (i) a cargo housing having a roof on top of the cargo housing, a housing compartment within the cargo housing, and a bottom bed; (ii) a retractable platform or retractable compartment which is extendable from a lateral side of the cargo housing to a deployed position for use and is retractable to a retracted position for transporting the trailer or truck, the retractable platform or retractable compartment having a floor which pivots upwardly to cover a side opening of the cargo housing when the retractable platform or retractable compartment is retracted to its retracted position; and (iii) at least one outrigger for supporting the floor of the retractable platform or retractable compartment when the retractable platform or retractable compartment is in its deployed position.

The outrigger preferably comprises (a) a pivot arm which is pivotable from a stowed position of the pivot arm beneath the bottom bed of the cargo housing to a deployed position of the pivot arm extending outwardly from the cargo housing and (b) a support element (e.g., a support block or other support element) which is positionable on top of the pivot arm in a supporting position of the support element. When (i) the pivot arm of the outrigger is in the deployed position of the pivot arm, (ii) the support element is positioned on top of the pivot arm in the supporting position of the support element, and (iii) the retractable platform or retractable compartment is in its deployed position, the floor of the retractable platform or retractable compartment will rest on the support element.

In another aspect, the support element of the outrigger can be pivotably attached to the pivot arm such that the support element is upwardly pivotable from (i) a lowered position which permits the pivot arm of the outrigger to be pivoted to the stowed position of the pivot arm beneath the bottom bed of the cargo housing to (ii) the supporting position of the support element on top of the pivot arm.

Further aspects, features, and advantages of the present invention will be apparent to those in the art upon examining the accompanying drawings and upon reading the following Detailed Description of the Preferred Embodiments.

### BRIEF DESCRIPTION OF THE DRAWINGS

FIG. 1 is an elevational front view of an embodiment 2 of the inventive trailer with the inventive trailer 2 having a flat roof.

FIG. 2 is an elevational front view of the inventive trailer 2 with the trailer 2 having a gabled roof.

FIG. 3 is a perspective view of the inventive trailer 2.

FIG. 4 is an elevational side view of the inventive trailer 2.

FIG. 5 is a perspective interior view of the inventive trailer 2.

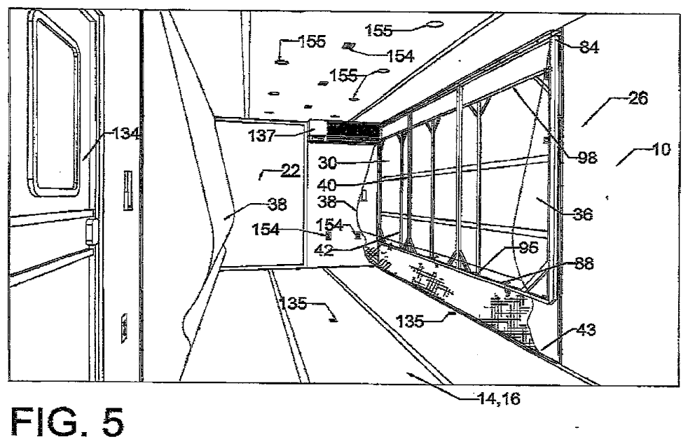

FIG. 6 is another perspective view of the inventive trailer 2.

FIG. 7 is another perspective view of the inventive trailer 2.

FIG. 8 is another perspective view of the inventive trailer 2.

FIG. 9 is another perspective view of the inventive trailer 2.

FIG. 10 is another perspective view of the inventive trailer 2.

FIG. 11 is another perspective view of the inventive trailer 2.

FIG. 12 is another perspective view of the inventive trailer 2.

FIG. 13 is another perspective view of the inventive trailer 2 with the collapsible tents 38 thereof removed.

FIG. 14 is an upper interior view of the inventive trailer 2.

FIG. 15 is a side interior view of the inventive trailer 2.

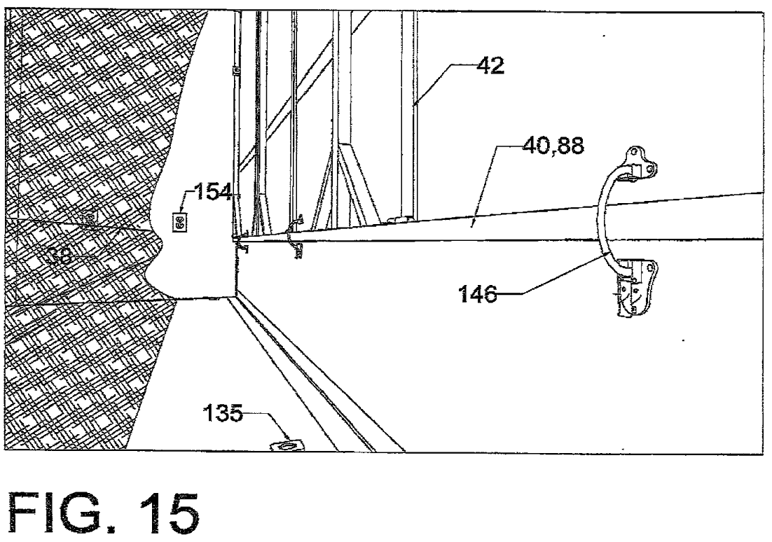

FIG. 16 is another upper interior view of the inventive trailer 2.

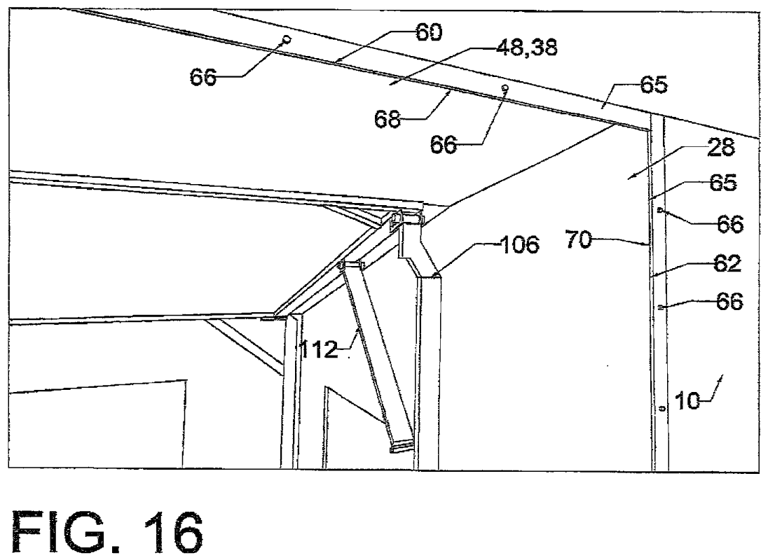

FIG. 17 is a partial exterior view of the inventive trailer 2.

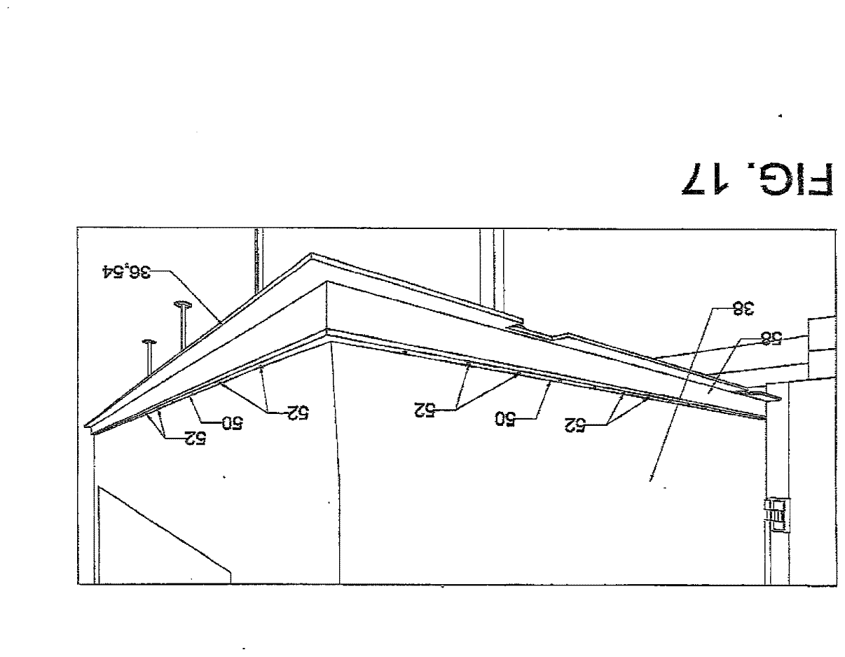

FIG. 18 is an interior view of the inventive trailer 2 with the collapsible tents 38 thereof removed.

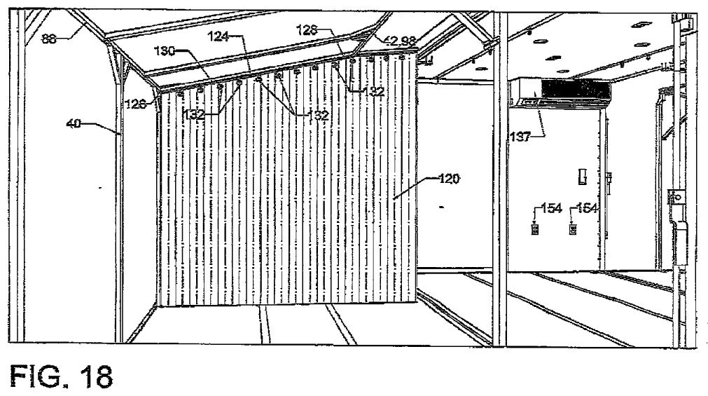

FIG. 19 is a rearward facing interior view of the inventive trailer 2.

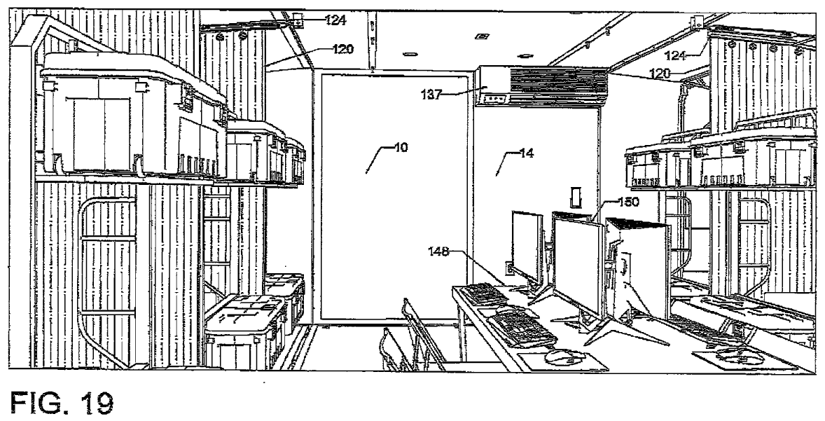

FIG. 20 is a cutaway top view of the inventive trailer 2.

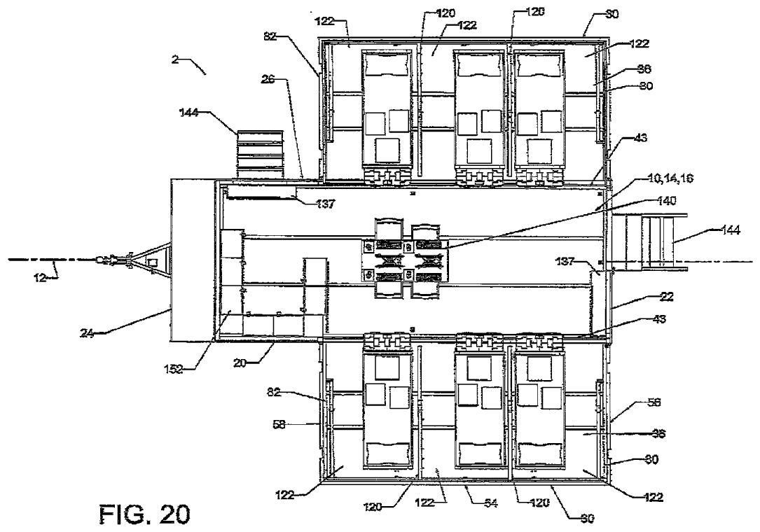

FIG. 21 is a cutaway top perspective view of the inventive trailer 2.

FIG. 22 is a cutaway top perspective view of an embodiment 200 of the truck provided by the present invention, with the tent compartment assemblies 30 thereof deployed.

FIG. 23 is a cutaway top perspective view of the inventive truck 200 wherein the tent compartment assemblies thereof are closed and the truck is carrying cargo therein.

FIG. 24 is a perspective view of the inventive truck 200 with an embodiment 300 of the inventive covering system thereon.

FIG. 25 is an elevational side view of the inventive trailer 2 with the inventive covering system 300 thereon.

FIG. 26 is a top view of the inventive trailer 2 with the inventive covering system 300 thereon.

FIG. 27 is a perspective view of the inventive trailer 2 with the inventive covering system 300 thereon.

FIG. 28 is an elevational front view of the inventive trailer 2 with the inventive covering system 300 thereon.

FIG. 29 is an elevation view of an outwardly extending support frame 306 used in the inventive covering system 300.

FIG. 30 is a top view of the inventive trailer 2 with an embodiment 350 of the inventive covering system thereon.

FIG. 31 is a perspective view of the inventive trailer 2 with an embodiment 400 of the inventive covering system thereon.

FIG. 32 is a top view of the inventive trailer 2 with the inventive covering system 400 thereon.

FIG. 33 is an elevational side view of the inventive trailer 2 with the inventive covering system 400 thereon.

FIG. 34 is an elevational front view of the inventive trailer 2 with the inventive covering system 400 thereon.

FIG. 35 is a perspective view of the inventive trailer 2 with the inventive covering system 400 thereon.

FIG. 36 is a perspective view of an outrigger assembly 210 used in the inventive trailer 2 or truck 200.

FIG. 37 is a perspective view of the outrigger assembly 210 in a 90° pivoted position.

FIG. 38 is a perspective view of the outrigger assembly 210 in its 90° deployed position with the compensating support block 216 of the outrigger assembly 210 in it its raised.

FIG. 39 is a perspective view of the inventive trailer 2 having an embodiment 500 of the inventive covering system thereon.

FIG. 40 is a top perspective view of the inventive trailer 2 wherein a series of longitudinally spaced apart lateral channels 502 used in the inventive covering system 500 are secured on the roof 18 of the cargo housing 10.

FIG. 41 is a rear elevational view of an upper portion of the inventive trailer 2 wherein a left cover support frame 504 and a right cover support frame 506 are received and held in each of the lateral channels 502.

FIG. 42 shows the left or right cover support frame 504 or 506 of the inventive cover system 500 in a folded position for stowage and transport.

### DETAILED DESCRIPTION OF THE PREFERRED EMBODIMENTS

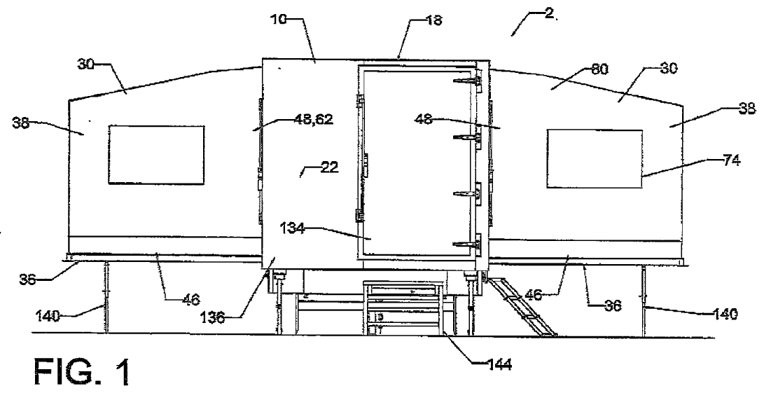

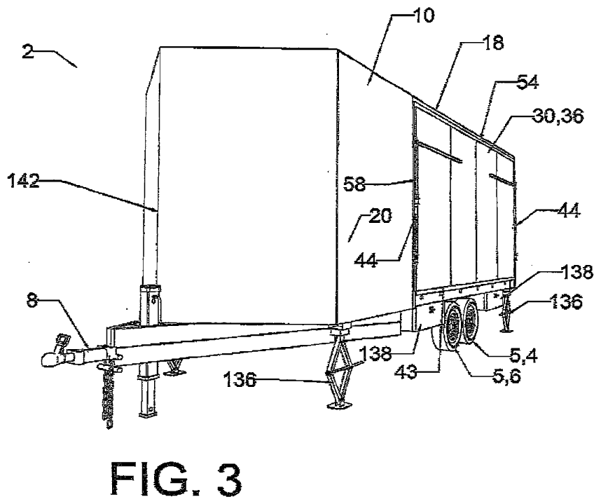

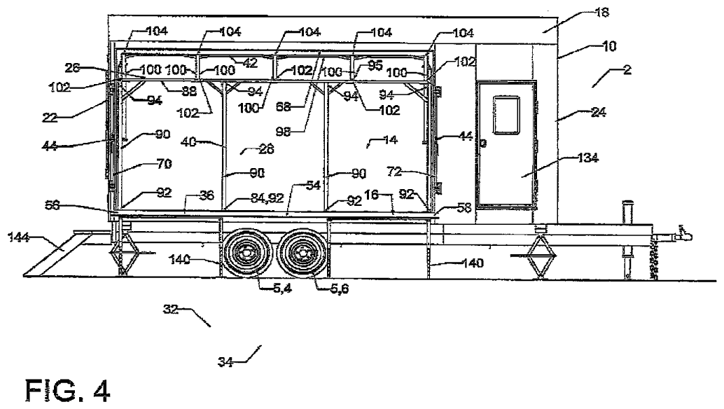

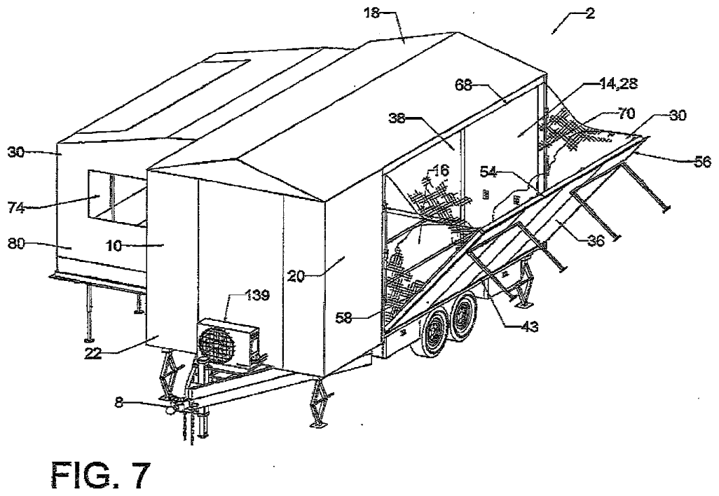

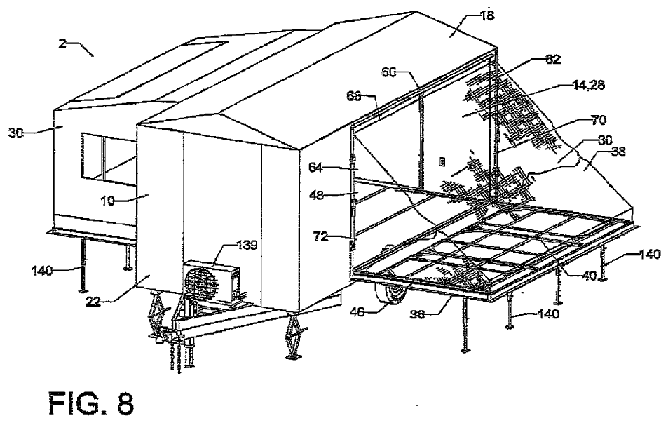

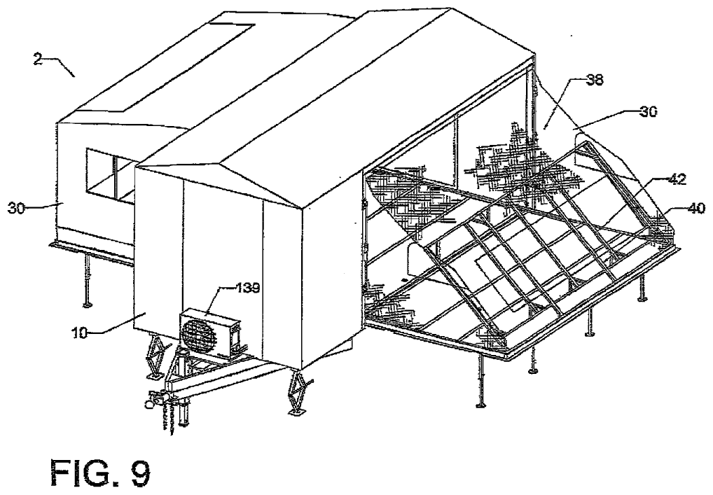

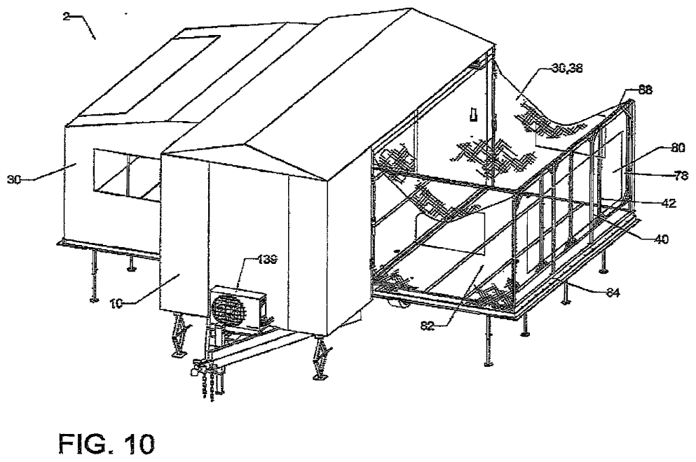

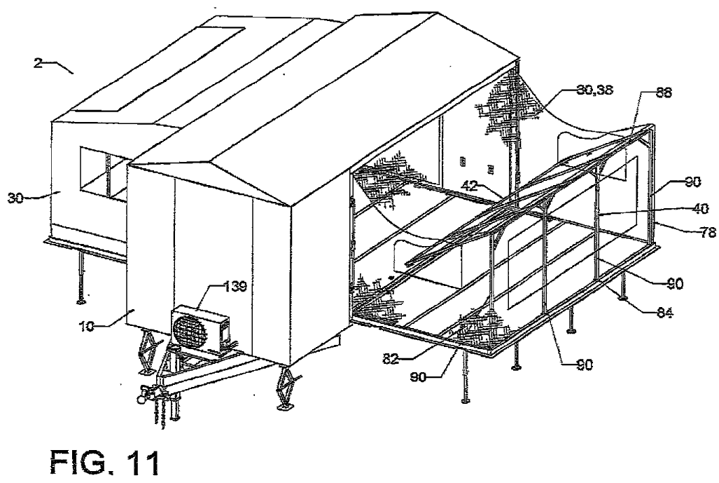

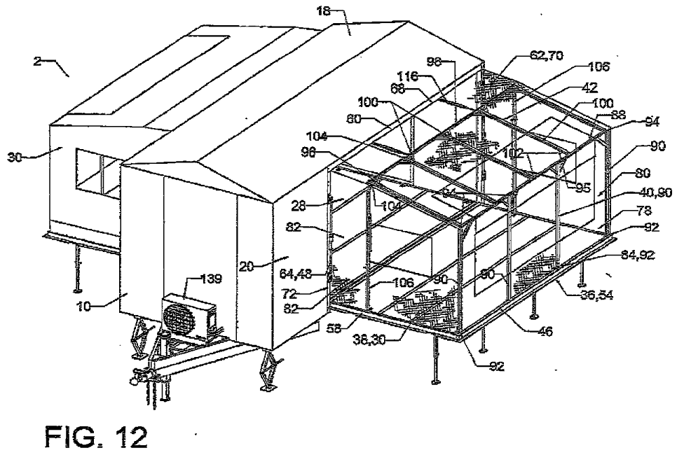

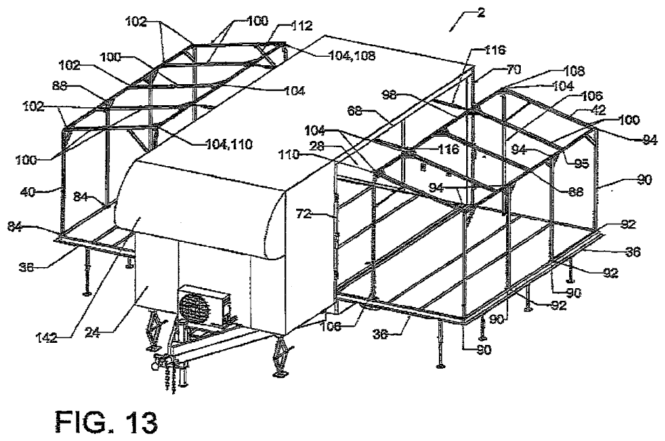

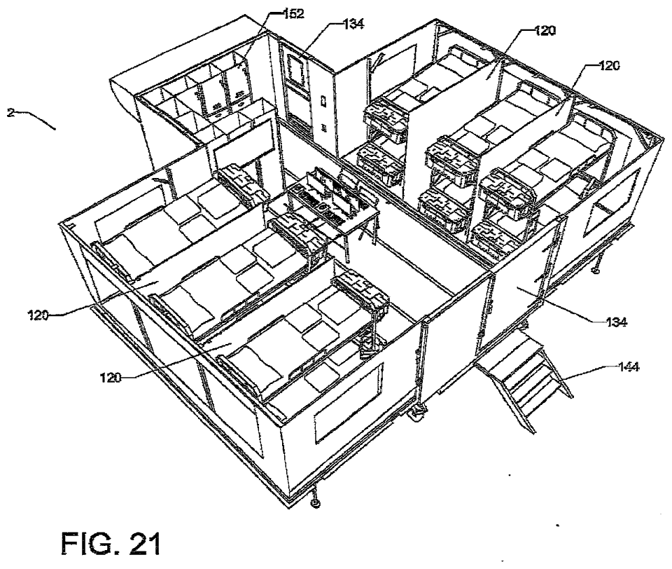

An embodiment 2 of the trailer provided by the present invention is illustrated in FIGS. 1-4, 6-13, and 21. The inventive trailer 2 has dual axles 4 and 6, four wheels 5, and a standard trailer hitch 8 for towing by any type of truck or other vehicle. It will be understood, however, that the trailer 2 can alternatively (i) be a gooseneck-style trailer with a gooseneck trailer hitch, (ii) use any other type of hitch, (iii) be of any desired size and have only one axle or any other number of axles and wheels, and/or (iv) be a semi-trailer pulled by a semi-truck.

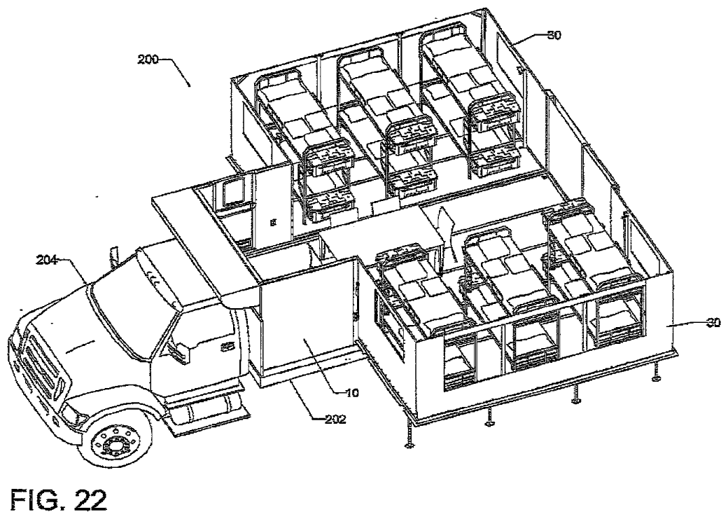

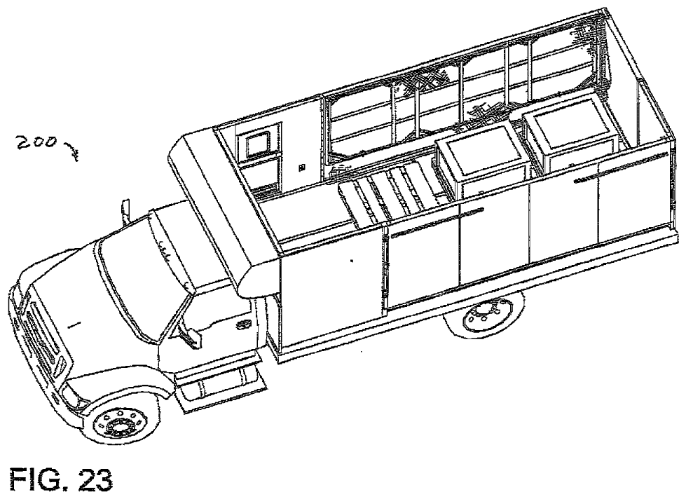

An embodiment 200 of the truck provided by the present invention is illustrated in FIGS. 22 and 23. The embodiment 200 of the inventive truck is identical to the embodiment 2 of the inventive trailer except that, whereas the trailer 2 has a trailer hitch 8 for towing, the inventive truck 200 has a fixed bed 202 which extends rearwardly behind the cab 204 of the truck 200. Consequently, unless otherwise expressly indicated, all of the other elements and features discussed herein for the inventive trailer 2 also apply to the inventive truck 200.

The inventive trailer 2 preferably comprises a cargo housing 10 having: a longitudinal axis 12; a cargo compartment (housing compartment) 14 in the cargo housing 10; a cargo bed 16 which extends longitudinally in the bottom of the cargo housing 10; a roof 18 spaced above the cargo bed 16; a first substantially vertical side 20 which extends longitudinally between the rearward longitudinal end 22 and the forward longitudinal end 24 of the cargo housing 10; and a second substantially vertical side 26, opposite and preferably parallel to the first substantially vertical side 20, which extends longitudinally between the rearward longitudinal end 22 and the forward longitudinal end 24 of the cargo housing 10.

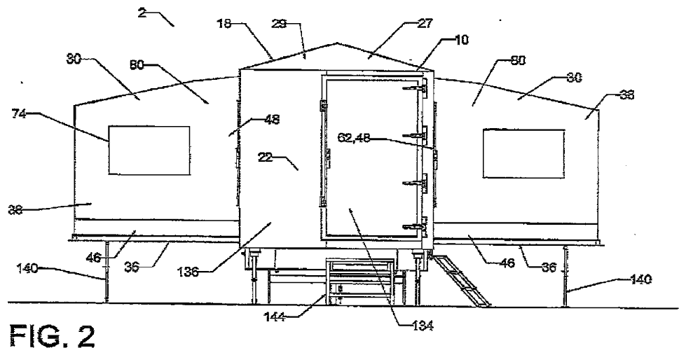

By way of example, but not by way of limitation, the roof 18 of the cargo housing 10 can be a flat roof, as shown in FIG. 1, or a gable-type roof, as illustrated in FIG. 2, having (a) a right lateral half 27 which slopes downwardly as it extends laterally outward to the right and (b) a left lateral half 29 which slopes downwardly as it extends laterally outward to the left.

On one or both of the first and second sides 20 and/or 26 of the cargo housing 10, the inventive trailer 2 preferably also comprises: (i) a side opening 28 and (ii) a tent compartment assembly 30 which is associated with the side opening 28.

In each case, the side opening 28 preferably (a) extends upwardly from the cargo bed 16 to the roof 18 of the cargo housing 10 and (b) has a longitudinal length 32 which is at least half, more preferably at least two thirds, of the longitudinal distance 34 measured from the rearward longitudinal end 22 to the forward longitudinal end 24 of the cargo housing 10. The longitudinal length 32 of each side opening 28 can be substantially equal to the longitudinal length 34 of the cargo housing 10 but will more preferably be in the range of from 60% to 90%, or from 65% to 85% or from 65% to 80%, of the longitudinal length 34 of the cargo housing 10.

Each tent compartment assembly 30 used in the inventive trailer 2 preferably comprises: a side panel 36; a collapsible tent 38; a tent wall frame 40; and a tent roof frame 42. The side panel 36 has a lower end 43 which is pivotably connected to the cargo housing 10 for pivoting the side panel 36 (i) from a raised (preferably vertical or substantially vertical) position, in which the side panel 36 covers and closes the side opening 28, to at least (ii) a lowered/deployed (preferably horizontal or substantially horizontal) position in which the side panel 36 becomes a floor of the tent compartment assembly 30. For each tent compartment assembly 30, latches 44 are provided on the cargo housing 10 for releasably latching the side panel 36 in its closed/raised position over the side opening 28.

The collapsible tent 38 of each tent compartment assembly 30 preferably comprises (a) a tent bottom end 46 which is attached to the side panel 36 of the tent compartment assembly 30 and (b) an inner side 48 which is attached to the cargo housing 10. The bottom end 46 of the tent 38 comprises outer, rearward, and forward edges which are preferably attached (using, e.g., flat aluminum strips 50 and bolts 52) along at least most (more preferably along all or substantially all) of the entire length of each of (i) the longitudinally extending outer edge 54 of the side panel 36, (ii) the rearward edge 56 of the side panel 36, and (iii) the forward edge 58 of the side panel 36. The rearward and forward edges 56 and 58 of the side panel 36 are preferably perpendicular to the longitudinally extending outer edge 54.

When referring to lengths or distances, the term “substantially,” as used herein and in the claims, within 6 inches. When referring to an “angle” or to “vertical” or “horizontal” orientations, the term “substantially,” as used herein and in the claims, means within a range of ±10°. The term “about,” as used herein and in the claims, means ±10%.

For each tent compartment assembly 30, the inner side 48 of the collapsible tent 38 comprises a longitudinal upper edge 60, a substantially vertical rearward edge 62, and a substantially vertical forward edge 64 which are preferably attached (using, e.g., flat aluminum strips 65 and bolts 66) along at least most (more preferably along all or substantially all) of the entire length of each of the longitudinal top end 68, the substantially vertical rearward end 70, and the substantially vertical forward end 72 of the corresponding side opening 28 of the cargo housing 10. When the inner side 48 of the collapsible tent 38 is attached over a side opening 28 of the cargo housing 10 in this or a similar manner, the side opening 28 of the cargo housing 10 becomes an entryway for the tent compartment assembly 30 when the side panel 36 of the tent compartment assembly 30 is placed in its substantially horizontal deployed position.

By way of example, but not by way of limitation, the collapsible tent 38 of each collapsible tent assembly 30 will preferably be formed of waterproof polyester fabric, laminated PVC, nylon fabric, other plastic, canvas, sailcloth, hemp fabric, flax fabric, cotton fabric, infrared fabric, or a combination thereof. The collapsible tent 38 can also include any number and any type of open, plastic, or other tent windows 74, with or without fabric, plastic, mesh, or other covers 76. One or more windows 74 can be provided in any of the substantially vertical outer wall 78, the substantially vertical rearward wall 80, and/or the substantially vertical forward wall 82 of the tent 38.

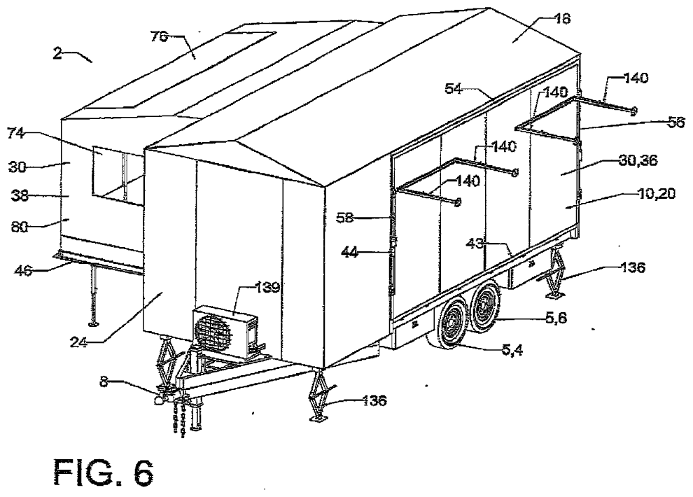

The tent wall frame 40 of each tent compartment assembly 30 is preferably a flat frame having a lower end 84 which is pivotably attached to the side panel 36 of the tent compartment assembly 30 so that when the side panel 36 is in its substantially horizontal deployed position, the tent wall frame 40 can be pivoted upwardly inside the collapsible tent 38 (as sequentially illustrated in FIGS. 6-10) to a raised position in which the tent wall frame 40 raises and supports the outer substantially vertical wall 78 of the collapsible tent 38. When the outer wall 78 of the collapsible tent 38 is raised by the tent wall frame 40, the outer wall 78 of the collapsible tent 38 is opposite, and will preferably be substantially parallel to, both the inner side 48 of the tent 38 and the side opening 28 of the cargo housing 10.

The longitudinal length of the tent wall frame 40 is preferably (i) at least 90% of the longitudinal length 32 of the side opening 28 of the cargo housing 10 but (ii) less than the longitudinal length 32 of the side opening 28 so that the tent wall frame 40 will be received through the side opening 28 when the side panel 36 of the collapsible compartment assembly 30 is raised to its closed position. The lower end 84 of the tent wall frame 40 is preferably pivotably attached along and at or near the substantially longitudinally extending outer edge 54 of the side panel 36 such that the lower end 84 of the tent wall frame 40 will also be received through the side opening 28 of the cargo housing 10 when the side panel 36 is closed.

The tent wall frame 40 preferably comprises: (i) a distal, longitudinally extending frame member 88 which is preferably parallel to the side panel 36 and (ii) a plurality of connecting frame members 90 which extend between the side panel 36 and the distal, longitudinally extending frame member 88. The connecting frame members 90 of the tent wall frame 40 preferably have proximal ends 92 which are pivotably connected to the side panel 36 and distal ends 94 which are connected to the distal, longitudinally extending frame member 88 of the tent wall frame 40.

The tent roof frame 42 of the tent compartment assembly 30 is preferably a flat frame having a proximal end 95 which is pivotably attached to the tent wall frame 40 so that when the tent wall frame 40 is pivoted upwardly to the raised position of the tent wall frame 40, the tent roof frame 42 can be pivoted upwardly inside the collapsible tent 38 to a raised position to raise and support a roof 96 of the collapsible tent 38.

The tent roof frame 42 preferably comprises: (i) a distal, longitudinally extending frame member 98 which is preferably parallel to the distal, longitudinally extending frame member 88 of the tent wall frame 40 and (ii) a plurality of connecting frame members 100 which extend between the distal, longitudinally extending frame member 88 of the tent wall frame 40 and the distal, longitudinally extending frame member 98 of the tent roof frame 42. The connecting frame members 100 of the tent roof frame 42 preferably have proximal ends 102 which are pivotably connected to the distal, longitudinally extending frame member 88 of the tent wall frame 40 and distal ends 104 which are connected to the distal, longitudinally extending frame member 98 of the tent roof frame 42.

Each tent compartment assembly 30 also preferably comprises a pair of vertical support poles 106 which are removably installed between the lowered side panel 36 of the compartment assembly 30 and the tent roof frame 42 in order to hold the tent roof frame 42 and the roof 96 of the tent 38 in raised position. The two vertical support poles 106 preferably extend from the lowered side panel 36 to the rearward and forward distal/inner corners 108 and 110 of the tent roof frame 42. Additional angled supports 112 and 114 are also preferably provided which extend at an angle between the vertical support poles 106 and the outer (i.e., the rearward-most and forward-most) connecting members 100 of the tent roof frame 42.

In addition, each tent compartment assembly 30 preferably further comprises one or more, preferably a plurality, of tensioners 116 which extend from the distal, longitudinally extended frame member 98 of the tent roof frame 42 to the underside of the roof 18 of the cargo housing 10. The one or more tensioners 116 tension/pull the tent roof frame 42 toward the roof 18 of the cargo housing 10 to stretch the collapsible tent 38. This makes the collapsible tent 38 more taught and prevents sagging.

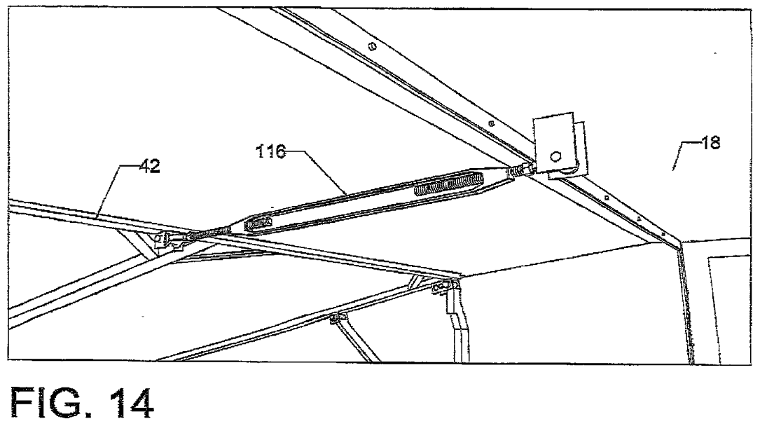

By way of example, but not by way of limitation, the one or more tensioners 116 can be bungy cords, having attachment hooks on the ends thereof, which extend, e.g., between attachment loops provided on the tent roof frame 42 and on the underside of the roof 18 of the cargo housing 10. As another example, the one or more tensioners 116 can be mechanical, threaded, piston type, open-body turnbuckle-type tensioners as illustrated in FIG. 14. Mechanical tensioners such as shown in FIG. 14 can be used to not only pull the tent roof frame 42 toward the roof 18 of the cargo housing, but to alternatively tension the tent roof frame 42 away from the roof 18 if needed to make the collapsible tent 38 more taught and prevent sagging.

To provide greater privacy, efficiency, and/or organization, each tent compartment assembly 30 also preferably includes one or more dividers 120. The one or more dividers 120 are preferably laterally oriented so that they can be (i) expanded toward the cargo housing 10 to divide the tent compartment assembly 30 into a series of two or more sleeping, working, medical treatment, or other areas 122 or (ii) retracted toward the outer wall 80 of the tent 38 for use of the tent compartment 30 as an open area for dining or any other purpose.

By way of example, but not by way of limitation, the one or more dividers 120 can be suspended from divider rods 124 which are removably positionable in the tent compartment assembly 30 when the tent wall frame 40 and the tent roof frame 42 are pivoted to their raised positions. The divider rods 124 can be held in the tent compartment assemble 30 in any manner suitable for suspending, and preferably also for extending and retracting, the dividers 120.

Also by way of example, but not by way of limitation, each of the one or more divider rods 124 preferably has (i) a proximal end or a proximal end portion 126 which is removably placed on or otherwise supported by the distal, longitudinally extending frame member 88 of the tent wall frame 40 and (ii) a distal end or a distal end portion 128 which is removably placed on or otherwise supported by the distal, longitudinally extending frame member 98 of the tent roof frame 42.

When extended, each of the suspended dividers 120 can divide the tent compartment assembly 30 into (a) a bunk, office, or other area 122 on the longitudinally rearward side of the divider 120 and (b) a separate bunk, office, or other area 122 on the longitudinally forward side of the divider 120. Examples of dividers 120 suitable for use in the tent compartment assembly 30 include, but are not limited to, curtains, laminated foam panels, or accordion-type dividers. Each divider 120 will preferably be a curtain having an upper end 130 which is slidably suspended from a corresponding divider rod 124 using a plurality of curtain hooks and/or loops 132.

It will be understood that any desired number of dividers 120 can be used to divide each tent compartment assembly 30 into any desired number of subcompartments. It will also be understood that the divider rods 124 can be placed laterally across the distal, longitudinally extending frame member 88 of the tent wall frame 40 and the distal, longitudinally extending frame member 98 of the tent roof frame 42 at any locations desired to so that the width of the subcompartments can be the same or different. Also, the divider rods 124 can be moved and/or the number of the divider rods 124 can be changed to add or subtract subcompartments and/or change or vary the widths thereof.

It will be further understood that similar divider rods can be placed longitudinally across the lateral connecting frame members 100 of the tent roof frame 42 to provide adjustable dividers which extent longitudinally in the tent compartment assembly 30.

Doors 134 can be provided in any one or more of the first side 20, the second side 26, and/or the rear wall 136 of the cargo housing 10. A door 134 will preferably be provided in either the first side 20 or the second side 26 of the cargo housing 134. If the door 134 is provided in a side 20 or 26 having a side opening 28 therein, the door 134 will preferably be located forwardly of the substantially vertical forward end 72 or rearwardly of the substantially vertical rearward end 70 of the side opening 28.

The inventive trailer 2 and truck 200 will preferably further include: tie-down rings or hooks 135 in the cargo bed 16 for securing pallets and cargo; climate control system interior units 137; and climate control system exterior units 139.

The inventive trailer 2, or the inventive truck 200, can also include or use any or all of: (a) scissor screw jacks 136 or similar devices for leveling the cargo bed 16 of the cargo housing 10; (b) one or more storage compartments 138 secured below the cargo bed 16 or elsewhere; (c) adjustable legs 140 removably attachable to the exterior side of the side panel 36 of each tent compartment assembly 30 to support and level the side panel 36 in its lowered/deployed position; (d) a wind nose or cone 142, e.g., of the type commonly used on trailers and trucks, which projects from the forward longitudinal end 24 of the cargo housing 10 to reduce wind resistance and increase fuel efficiency; (e) at least one set of stairs 144 which can be carried in the cargo housing 10 during transport; (f) latches 146 which extend over the longitudinally extending distal frame member 88 of each tent compartment assembly 30 to hold the tent wall frame 40 and the tent roof frame 42 against the side panel 36 of the compartment assembly 30 during transport; (g) a conference table 148, work stations 150, and/or personal storage lockers 152 removably or permanently installed in the cargo housing 10; (h) an aluminum sheeting exterior that can be wrapped with any logo, design, or color; (i) a 50 amp or other electrical panel for hook-up to a power grid or to an electrical generator; (j) interior power outlets 154 and lighting 155; and/or (k) any hook-ups and supports needed for water, climate control units, etc.

Consequently, each of the one or more tent compartments 30 of the trailer 2 or truck 200 as described above is a retractable compartment 30 which is (i) extendable from the cargo housing 10 to a deployed position for use and (ii) retractable to a retracted position for transporting the trailer 2 or the truck 200. It will also be understood that (a) other types of retractable compartments can alternatively be used in the inventive expandable trailer 2 or truck 200 and that (b) the collapsible tent 38 of any of the one or more retractable compartments 30, as well as the tent frame 40 therefor, can be omitted or removed such that the floor 36 of each such compartment becomes an open-air retractable platform 30. Such retractable platforms 30 are well-suited for band performances or for use as speaking platforms or for any number of other purposes.

As another alternative for supporting the floors 36 of the retractable side compartments or platforms 30 of the cargo housing 10 of the inventive trailer 2 or truck 200, the adjustable legs 140 for supporting the lowered side panels 36 of the cargo housing 10 can be replaced with, or used in addition to, one or more (preferably two) outriggers 210 which are provided on each side of the cargo housing 10.

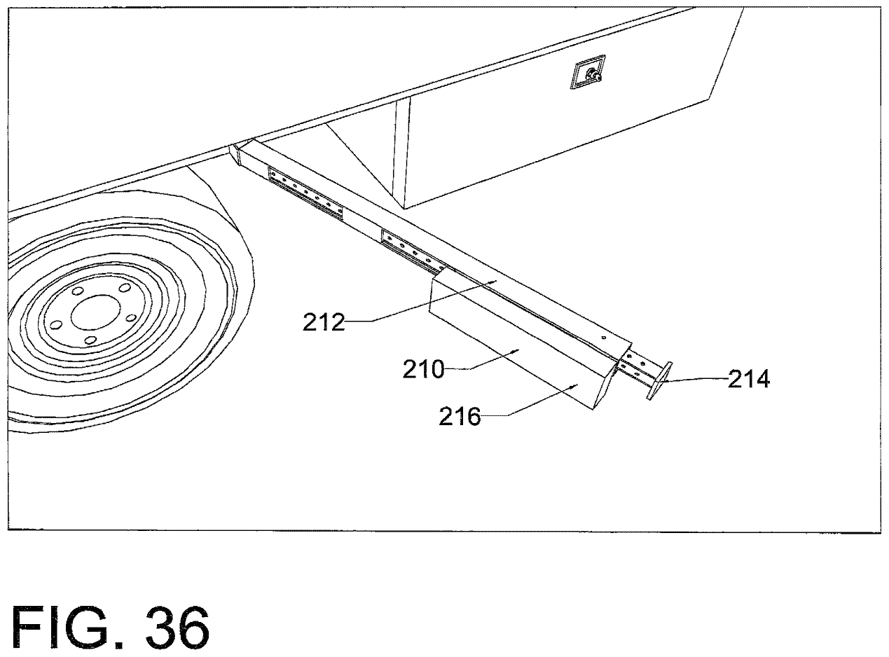

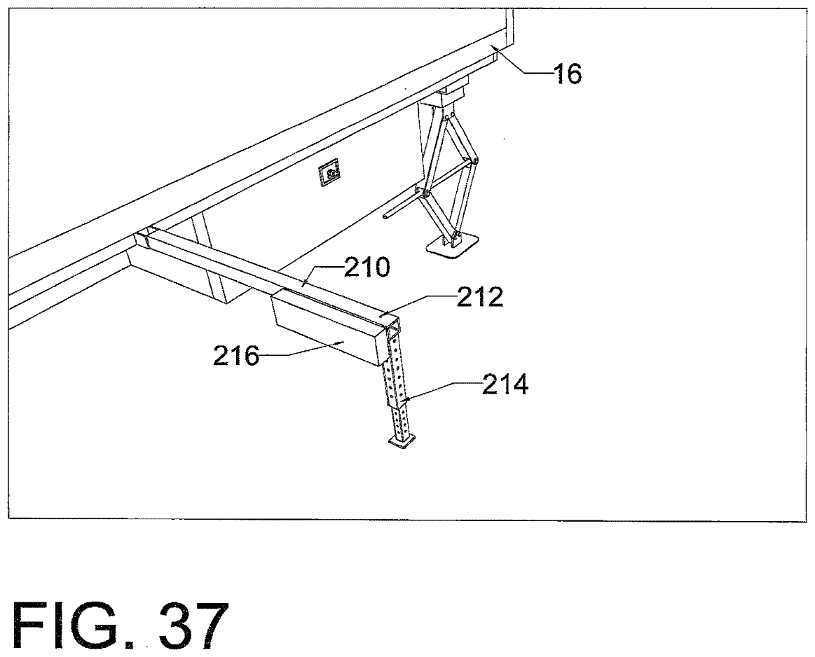

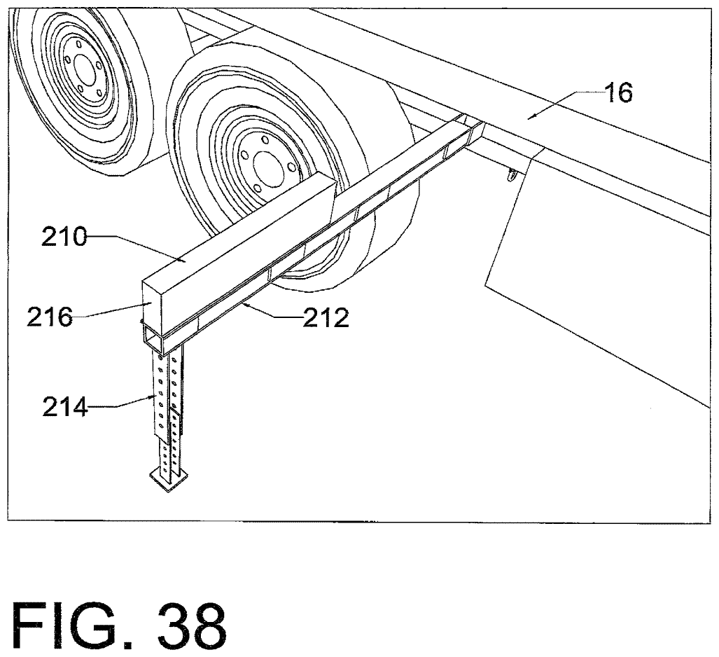

As illustrated in FIGS. 36-38, each of the outriggers 210 preferably comprises: (i) an elongate pivot arm 212 having a proximal end which is pivotably attached beneath the cargo bed 16 of the trailer 2 or truck 200, wherein the pivot arm 212 is preferably pivotable (preferably substantially horizontally pivotable) to an outward deployed angle of substantially 90° with respect to the cargo bed 16; (ii) a height adjustable leg 214 which is removable insertable into the distal end of the pivot arm 212 for stowing and transport and is attachable to the distal end of the pivot arm 212 for use such that the height adjustable leg 214 extends downwardly from the distal end of the pivot arm 212 at an angle of substantially 90° for supporting the distal end of the pivot arm 212 above a ground surface; (iii) a compensating support block or other compensating support element 216 which is positionable on top of the pivot arm 212 in a supporting position; and (iv) a latch for securing the outrigger 210 in its folded position beneath the cargo bed 16 for travel. The compensating support element 216 is preferably pivotably attached to and extends along a distal portion of the pivot arm 212.

The compensating support element 216 of the outrigger 210 is pivotable between (a) a lowered position in which the compensating support element 216 runs along the side of the pivot arm 212 and (b) a raised position (i.e., the supporting position) in which the compensating support element 216 rests on top of the pivot arm 212. When the compensating support element 216 is in its lowered position, the outrigger 210 can be folded to its stowed travel position beneath the cargo bed 16 for travel. When the outrigger 210 is pivoted outwardly to its deployed position and the compensating support element 216 is pivoted upwardly to its raised (supporting) position on top of the pivot arm 212, the height of the compensating support element 216 compensates for the width of the cargo bed 16 so that the floor 36 of each retractable compartment or platform 30 will be supported in its horizontal deployed position on top of the raised compensating support element 216.

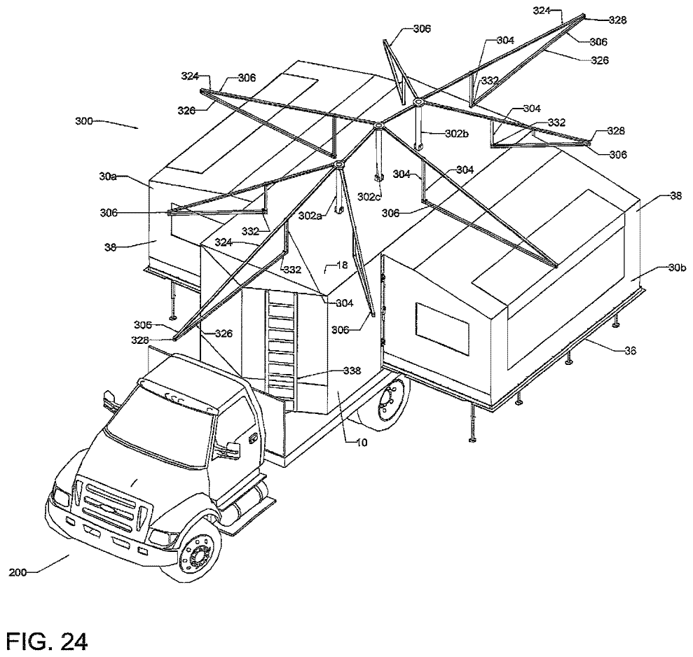

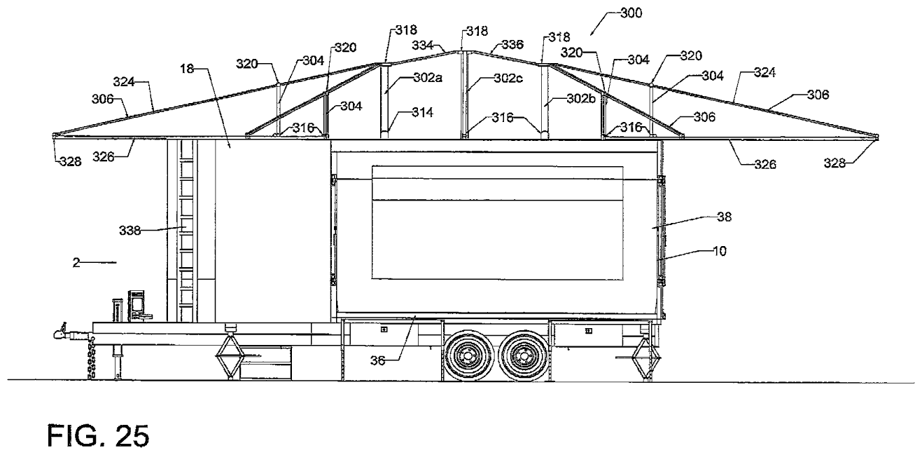

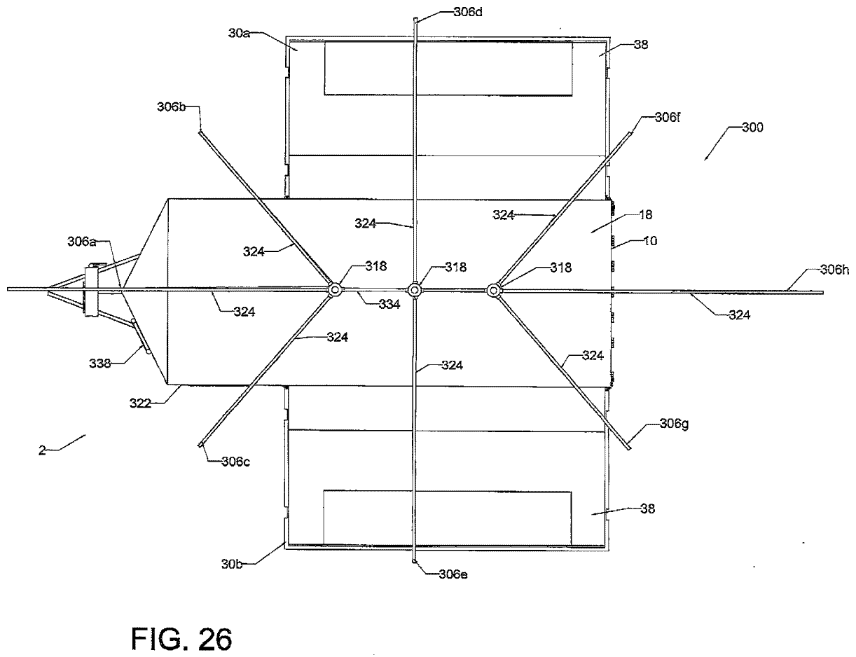

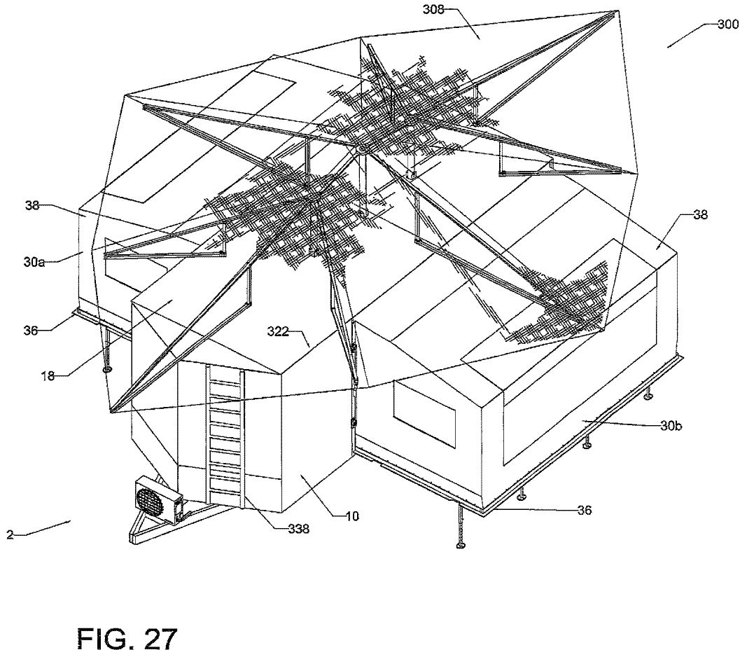

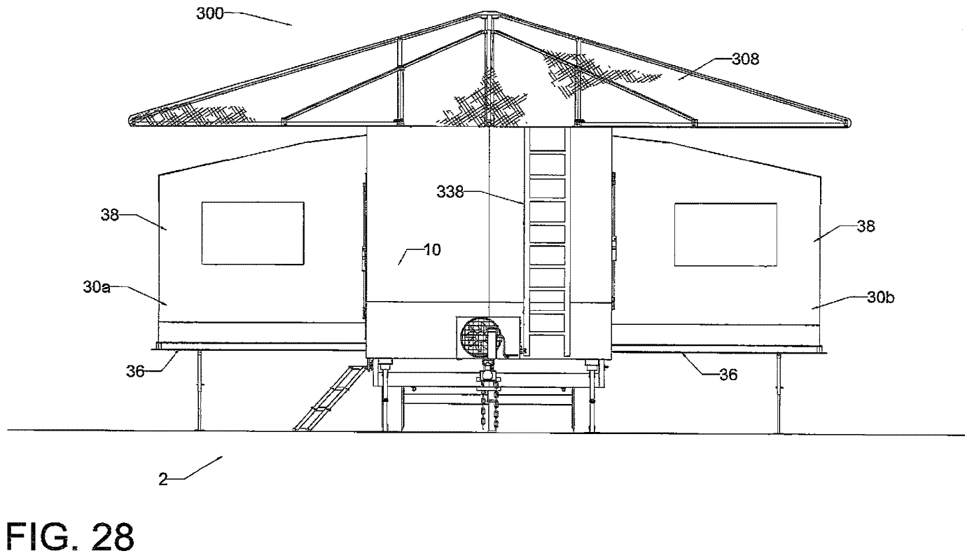

An embodiment 300 of the covering system provided by the present invention is illustrated in FIGS. 24-29. By way of example, but not by way of limitation, the inventive covering system 300 can be used on a trailer 2 or a truck 200 of the type described above. The cargo housing 10 of the trailer 2 or truck 200 will preferably, but need not necessarily, have a flat roof 18. Although the covering system 300 can also be used on a trailer or truck having no retractable compartments 30, the cargo housing 10 of the trailer 2 or truck 200 will preferably have one or more retractable compartments 30 and will more preferably have both a retractable compartment 30a on the left lateral side of the cargo housing 10 and a retractable compartment 30b on the right lateral side of the cargo housing 10. In addition, the covering system 300 can alternatively be used on a cargo housing 10 of a trailer 2 or truck 200 having one or more retractable platforms formed, e.g., by omitting or removing the collapsible tent 38 and the tent frame 40 from the floor 36 of a left compartment 30a and/or a right compartment 30b.

For the cargo housing 10 of either the trailer 2 or the truck 200, the inventive covering system 300 preferably comprises: (i) a plurality of upwardly extending first support structures 302 which will extend upwardly from the roof 18 of the cargo housing 10; (ii) a plurality of upwardly extending second support structures 304 which will also extend upwardly from the roof 18; (iii) a plurality of outwardly extending covering support frames 306; and (iv) a removable covering 308 which is removably positionable on the upwardly extending first support structures 302 and the outwardly extending frames 306.

Although other types of upwardly extending support structures (e.g., upwardly extending frame structures) can alternatively be used, each of the upwardly extending first support structures 302 and each of the upwardly extending second support structures 304 of the covering system 300 will preferably comprise a telescoping or non-telescoping segment of a post, elongate U-shaped channel member, conduit, pipe, bar, pole, or rod 310 or 312. The upwardly extending first support structures 302 and the upwardly extending second support structures 304 will preferably each comprise a telescoping segment of a post, conduit, pipe, bar, pole, or rod 310 or 312.

Brackets 314 and 316 are attached to the roof 18 of the cargo housing 10 for connecting the lower ends of the upwardly extending first support structures 302 and the lower ends of the upwardly extending second support structures 304 so that the first support structures 302 and the second support structures 304 will be (i) downwardly pivotable to a horizontal position on the roof 18 of the cargo housing 10 for travel and/or (ii) removably attachable to the roof 18.

Each of the upwardly extending first support structures 302 will preferably include, as part of the support structure 302, a connecting hub 318, or other connector, on the upper end thereof. Each of the upwardly extending second support structures 304, on the other hand, will preferably have a U-shaped receiving bracket 320 or other holding structure on the upper end thereof.

The upwardly extending second support structures 304 of the inventive covering system 300 are shorter than the upwardly extending first support structures 302 and are positioned either (i) between the first support structures 302 and the outer perimeter 322 of the roof 18 of the cargo housing 10 or (ii) on the outer perimeter 322 of the roof 18.

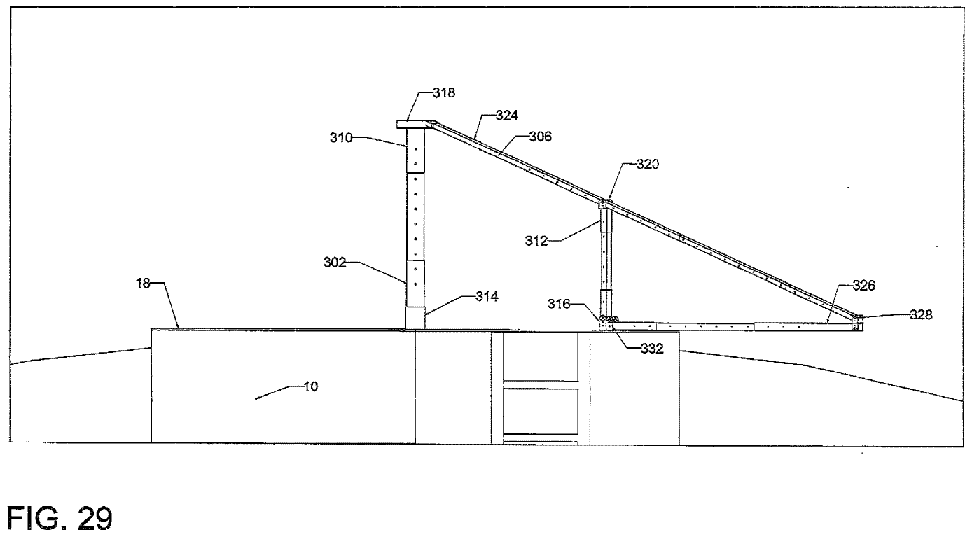

Each of the outwardly extending covering support frames 306 of the covering system 300 is preferably a removable and foldable frame comprising an elongate upper frame element 324 and an elongate lower frame element 326. The upper frame elements 324 and lower frame elements 326 of the covering support frames 306 can be either telescoping (see FIG. 29) or non-telescoping elements but will more preferably be lockable and releasable telescoping elements which facilitate stowing, transport, and use.

The proximal end of each upper frame element 324 is snapped in, pinned in, or otherwise connected to the connecting structure 318 on the upper end of one of the upwardly extending first support structures 302. In each case, or in at least most cases, the upper frame element 324 extends outwardly from the hub or other connector 318 at the top of the upwardly extending first support structure 302, slopes downwardly as it extends outwardly, has a mid-portion which is received in and supported by the U-shaped receiving bracket or other receiving structure 320 on the upper end of one of the upwardly extending second support structures 304, and extends outwardly beyond the upwardly extending second support structure 304.

The elongate lower element 326 of each of the outwardly extending covering support frames 306 is pivotably attached to a bracket 328 on the outer/distal end of the upper frame element 324 and preferably extends from the outer bracket 328 back toward the upwardly extending second support structure 304 on which the upper support element 324 rests. When the outwardly extending covering support frame 306 is installed, the elongate lower element 326 of the frame 306 preferably extends substantially horizontally toward the upwardly extending second support structure 304 and the distal return end of the lower frame element 326 is preferably snapped into, pinned in, or otherwise attached to a bracket 332 at the base of the upwardly extending second support structure 304.

The upwardly extending first support structures 302 on the roof 18 of the cargo housing 10 preferably include at least a forward-most first support structure 302a and a rearward-most first support structure 302b. More preferably, one or more (most preferably one, two, or three) additional upwardly extending first support structures 302c (i) will also be provided on the roof 18 of the cargo housing 10 between the forward-most first support structure 302a and the rearward-most first support structure 302b and (ii) will be taller than the forward-most first support structure 302a and the rearward-most first support structure 302b.

By way of example, the embodiment 300 of the inventive covering system illustrated in FIGS. 24-28 includes a third one of the upwardly extending first support structures 302c which is positioned between and is taller than the forward-most and rearward-most first support structures 302a and 302b. In addition, the covering system 300 also includes (i) a first connecting support rod, bar, or other element 334 which extends downwardly from the connector 318 on the upper end of the intermediate first support structure 302 to the connector 318 on the upper end of the forward-most first support structure 302a and (ii) a second connecting support rod, bar, or other element 336 which extends downwardly from the connector 318 on the upper end of the intermediate first support structure 302c to the connector 318 on the upper end of the rearward-most first support structure 302b.

A ladder 338 is preferably provided on the exterior of the cargo housing 10 to assist the operator in climbing to the top of the roof 18 to (a) attach, pivot, or remove the upwardly extending first support structures 302, the upwardly extending second support structures 304, and the outwardly extending covering support frames 306 and (b) install or remove the removable covering 308.

The removable covering 308 can be formed of any material suitable for the conditions to which the inventive covering 300 will be subjected and can also be of any pattern, design, appearance, or functional nature desired. Examples of materials preferred for forming the removable covering 308 include, but are not limited to: canvas; vinyl fabric; PVC-coated mesh; laminated fabric; extruded film; 500D nylon; 1000D nylon; other grades of nylon; anti-microbial fabric; flame retardant fabric; or infrared fabric.

When in use, the removable covering 308 is placed over the upwardly extending first support structures 302 and the upper frame elements 324 of the outwardly extending covering support frames 306. The number, length, and orientation of the outwardly extending covering support frames 306 and the related size and configuration of the removable covering 308 are preferably such that the removable covering 308 will cover (i) all or at least most of the roof 18 of the cargo housing 10 and (ii) all or at least most of the top of each of the one or more retractable compartments or retractable platforms 30a and/or 30b of the trailer 2 or truck 200.

By way of example, but not by way of limitation, the embodiment 300 of the inventive covering system illustrated in FIGS. 24-28 operates to extend the removable covering 308 over all of the roof 18 of the cargo housing 10 and over at least most of the top of the left retractable compartment or platform 30a and at least most of the top of the right retractable compartment or platform 30b of the cargo housing 10. To provide this coverage, the depicted covering system 300 includes: (i) a covering support frame 306a which extends longitudinally forward from the forward-most first support structure 302a beyond the forward end of the cargo housing 10; (ii) an opposing pair of outwardly diverging covering support frames 306b and 306c which extend forwardly from the forward-most first support structure 302a, each at a 45° outward angle, beyond the outer perimeter 322 of the roof 18 of the cargo housing 10; (iii) a pair of opposing covering support frames 306d and 306e which extend laterally outward from the intermediate first support structure 302c, each at a 90° angle, beyond the left and right retractable compartments or platforms 30a and 30b; (iv) an opposing pair of outwardly diverging covering support frames 306f and 306g which extend rearwardly from the rearward-most first support structure 302b, each at a 45° outward angle, beyond the outer perimeter 322 of the roof 18 of the cargo housing 10; and (v) a covering support frame 306h which extends longitudinally rearward from the rearward-most first support structure 302b beyond the rearward end of the cargo housing 10.

The downward angle of the upper frame elements 324 facilitates the flow of rainwater off of the inventive covering system 300 and also gives the covering system 300 a tent-like appearance. The greater height of the intermediate first structure 302c versus the forward-most first support structure 302a and the rearward-most first support structure 302b also facilitates drainage. Moreover, the upwardly extending first support structures 302a, 302b, and 302c also provide an attractive tent-like, rustic, and/or other appearance by forming peaks of different heights in the inventive covering system 300.

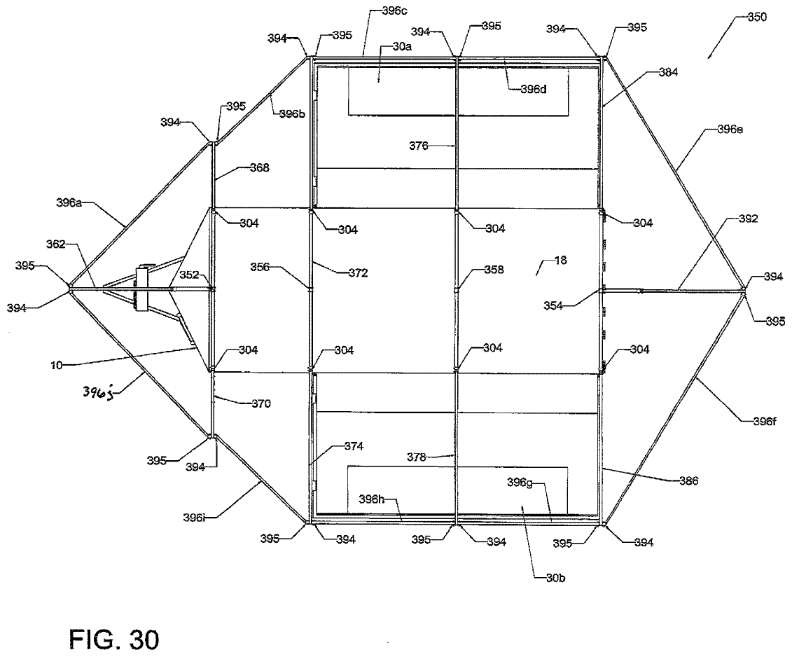

An alternative embodiment 350 of the inventive covering system which provides full coverage over the roof 18 of the cargo housing 10, and over each of the left and right retractable compartments or platforms 30a and 30b, is illustrated in FIG. 30. The inventive covering system 350 includes two, longitudinally spaced, intermediate upwardly extending first support structures 356 and 358 which are positioned longitudinally between the forward-most and rearward-most first support structures 352 and 354.

In addition, the covering system 350 also includes: (i) a covering support frame 362 which extends longitudinally forward from the forward-most first support structure 352 beyond the forward end of the cargo housing 10; (ii) a pair of opposing covering support frames 368 and 370 which extend laterally outward from the forward-most first support structure 352, each at a 90° angle; (iii) a pair of opposing covering support frames 372 and 374 which extend laterally outward from the leading intermediate first support structure 356, each at a 90° angle, beyond the left and right retractable compartments or platforms 30a and 30b; (iv) a pair of opposing covering support frames 376 and 378 which extend laterally outward from the trailing intermediate first support structure 358, each at a 90° angle, beyond the left and right retractable compartments or platforms 30a and 30b; (v) a pair of opposing covering support frames 384 and 386 which extend laterally outward from the rearward-most first support structure 354, each at a 90° angle, beyond the left and right retractable compartments or platforms 30a and 30b; and (vi) a covering support frame 392 which extends longitudinally rearward from the rearward-most first support structure 354 beyond the rearward end of the cargo housing 10. The covering system 350 also includes a removable covering which is positionable over the outwardly extending support frames 362, 368, 370, 372, 374, 376, 378, 384, 386, and 392.

Each of the support frames 362, 368, 370, 372, 374, 376, 378, 384, 386, and 392 of the covering system 350 also includes a left lateral attachment bracket 394 and a right lateral attachment bracket 395 on the distal end thereof. In addition, the covering system 350 further comprises a plurality of removable linking support elements 396a, 396b, 396c, 396d, 396e, 396f, 396g, 396h, 396i, and 396j which extend between the distal ends of each adjacent pair of the support frames 362, 368, 370, 372, 374, 376, 378, 384, 386, and 392 and are snapped into, pinned into, or otherwise connected to the left and right lateral attachment brackets 394 and 395 of each of adjacent pair of frames 362, 368, 370, 372, 374, 376, 378, 384, 386, and 392.

By way of example, but not by way of limitation, the linking support elements 396a, 396b, 396c, 396d, 396e, 396f, 396g, 396h, 396i, and 396j preferably each comprise a segment of square conduit. The left and right attachment brackets 394 and 395 on the distal ends of the removable support frames 362, 368, 370, 372, 374, 376, 378, 384, 386, and 392 will be oriented at whatever angles are needed for connecting the linking support elements 396a, 396b, 396c, 396d, 396e, 396f, 396g, 396h, 396i, and 396j.

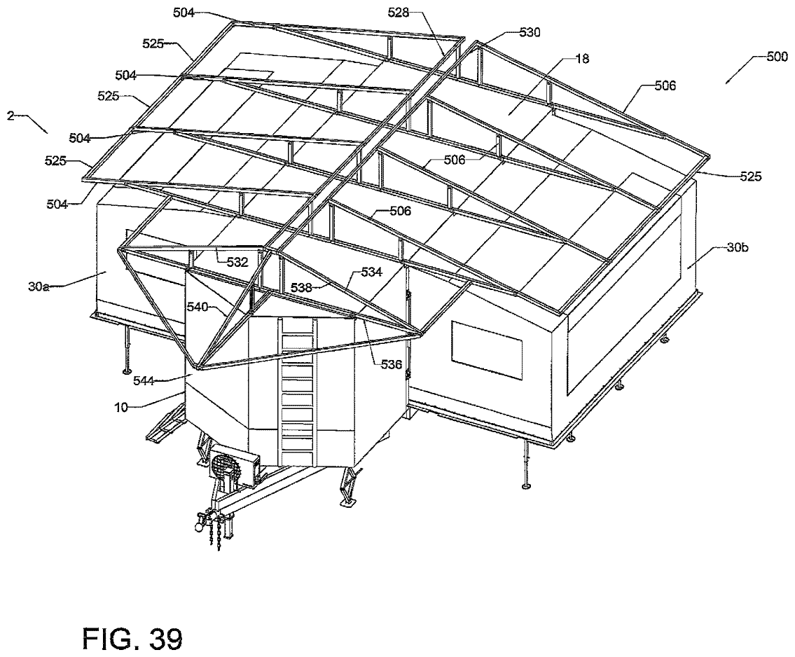

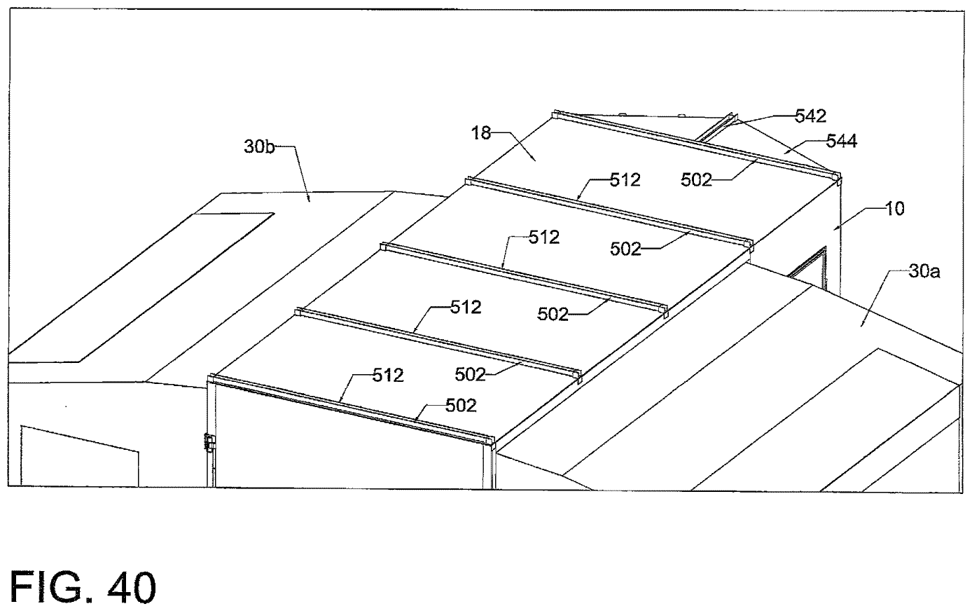

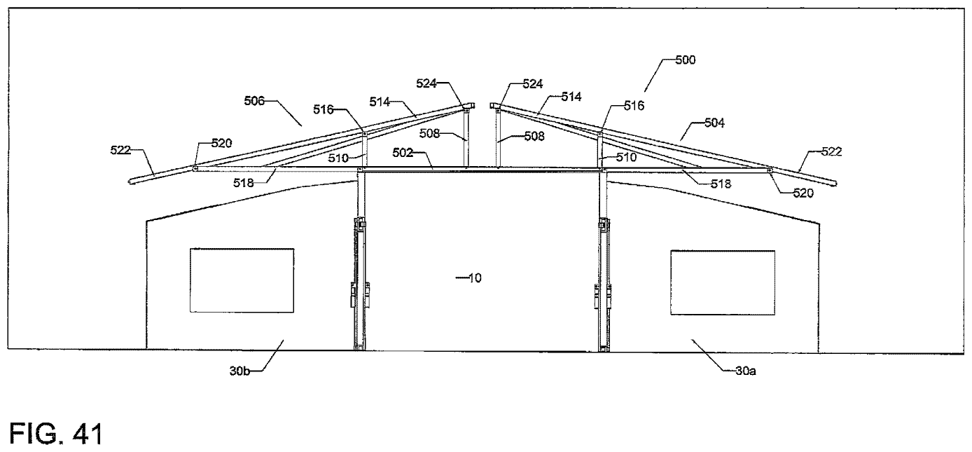

Another embodiment 500 of the inventive covering system is illustrated in FIGS. 39-42. The inventive covering system 500 is similar to the inventive covering systems 300 and 350. However, in addition to other differences, the inventive covering system 500 uses left and right cover support frames 504 and 506 which (i) are preferably folding frames, (ii) are received and held in a series of lateral channels 502 secured on the roof 18 of the cargo housing 10 of the inventive trailer 2 or truck 200 and (iii) include the upwardly extending first and second support structures 508 and 510 of the inventive covering system 500 as part of the folding cover support frames 504 and 506.

The inventive covering system 500 preferably comprises: a plurality of the lateral channels 502 secured on the roof 18 of the cargo housing 10; a first set of left and right cover support frames 504 and 506 which are received and held in at least most of the lateral channels 502; and a removable covering, of the same type describe above, which is positioned on, and supported over at least a portion of the roof 18 of the cargo housing 10 by, the set of left and right cover support frames 504 and 506.

Each of the lateral channels 502 is preferably a U-shaped channel (preferably a square or rectangular U-shaped channel) having an open top 512. The plurality of lateral channels 502 include at least a first lateral channel 502 and a second a second lateral channel 502. More preferably, the inventive covering system 500 includes three, four, five, or more of the lateral channels 502.

Each of the left and right cover support frames 504 and 506 preferably comprises: a first upwardly extending support structure 508, as mentioned above, having a lower end which is removably received and held in a supporting one of the lateral channels 502; a sloped upper frame element 514 which extends laterally outward, at a downward inclination, from an upper end or upper portion of the first upwardly extending support structure 508; and a second upwardly extending support structure 510, as mentioned above, having an upper end 516 which is attached at a mid-portion location of the sloped upper frame element 514 and having a lower end which is removably received and held in the same supporting one of the lateral channels 502, the first upwardly extending support structure 508 being taller than the second upwardly extending support structure 510.

Each of the left and right cover support frames 504 and 506 preferably also comprises a lower frame element 518 which (i) has an outer end 520 which is attached to the sloped upper frame element 514 of the cover support frame 504 or 506 at an outer location which is spaced outwardly from the mid-portion location at which the second upwardly extending support structure 510 is attached to the sloped upper frame element 514 and (ii) extends substantially horizontally from the outer location of the sloped upper frame element 514 back toward the lower end of the second upwardly extending support structure 510.

The sloped upper frame element 514 of each of the left and right cover support frames 504 and 506 in the first set of cover support frames preferably also includes an end segment 522 which extends outwardly, at a downward inclination, beyond the outer location at which the outer end 520 of the lower frame element 518 is attached to the sloped upper frame element 514. In addition, for each longitudinally adjacent pair of the cover support frames 504 or 506 of the first set of cover support frames, a linking support element 525 is preferably removably connected between the distal ends of the sloped upper frame elements 514 of the adjacent cover support frames 504 or 506.

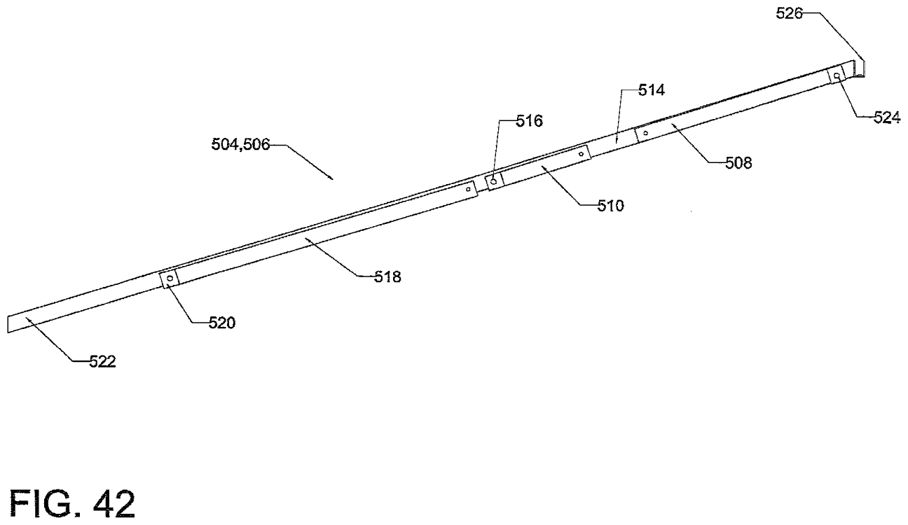

As also mentioned above, each of the left and right cover support frames 504 and 506 is preferably a folding frame as illustrated in FIG. 42 wherein: (a) the upper end 524 of the first upwardly extending support structure 508 of the cover support frame 504 or 506 is pivotably attached to the sloped upper frame element 514 of the cover support frame 504 or 506; (b) the first upwardly extending support structure 508 has a U-shaped channel in which the sloped upper frame element 514 is received when the first upwardly extending support structure 508 is pivoted to a folded position; (c) the upper end 516 of the second upwardly extending support structure 510 of the cover support frame 504 or 506 is pivotably attached to the sloped upper frame element 514; (d) the second upwardly extending support structure 510 has a U-shaped channel in which the sloped upper frame element 514 is received when the second upwardly extending support structure 510 is pivoted to a folded position; (e) the outer end 520 of the lower frame element 518 of the cover support frame 504 or 506 is pivotably attached to the sloped upper frame element 514; and (f) the lower frame element 518 has a U-shaped channel in which the sloped upper frame element 514 is received when the lower frame element 518 is pivoted to a folded position.

It will be understood, however, that the folding operation of the cover support frames 504 and 506 can alternatively be reversed such that the sloped upper frame element 514 of each of the support frames 504 and 506 is a U-shaped channel member in which each of the first upwardly extending support structure 508, the second upwardly extending support structure 510, and the lower frame element 520 are received when pivoted to their folded positions.

As with all of the other embodiments of the inventive covering system, the inventive covering system 500 is well suited for use on the inventive trailer 2, the inventive truck 200, or on generally any other type of trailer or truck having one or more retractable platforms or retractable compartments 30a and/or 30b which are (i) extendable from a cargo housing 10 to a deployed position for use and (ii) retractable to a retracted position for transporting the trailer 2 or truck 200. For each of the one or more retractable platforms or retractable compartments 30a and/or 30b, the removable covering of the inventive covering system 500 will be positioned over at least most of the top of the retractable platform or retractable compartment 30a or 30b when (i) the retractable platform or retractable compartment 30a or 30b is in its deployed position and (ii) the removable covering is positioned on at least the left and right cover support frames 504 and 506 of the first set of cover support frames.

In the inventive covering system 500, the first, second, and each succeeding lateral channel 502 on the roof 18 of the cargo housing 10 which is in alignment with the retractable platforms or retractable compartments 30a and 30b preferably has both a left cover support frame 504 and a right cover support frame 506 installed therein wherein: (a) the sloped upper frame elements 514 of the left cover support frames 504 installed in the first, the second and any succeeding lateral channels 502 extend laterally outward over a left side of the roof 18 of the cargo housing 10; (b) the sloped upper frame elements 514 of the right cover support frames 506 installed in the first the second, and any succeeding lateral channels 502 extend laterally outward over a right side of the roof 18 of the cargo housing 10; and (c) the removable covering system will be positioned on, and supported over at least a portion (more preferably all or about all) of the roof 18 of the cargo housing 10 by the left and the right cover support frames 504 and 506 installed in the first, the second, and any succeeding lateral channels 502.

The sloped upper frame elements 514 of the left cover support frames 504 installed in the first, the second, and any succeeding lateral channels 502 on the roof 18 of the cargo housing 10 which are in alignment with the retractable platform or compartment 30a, if present, will preferably also extend laterally outward over the platform or retractable compartment 30a. Similarly, the sloped upper frame elements 514 of the right cover support frames 504 installed in the first, the second, and any succeeding lateral channels 502 on the roof 18 of the cargo housing 10 which are in alignment with the retractable platform or compartment 30b, if present, will preferably also extend laterally outward over the platform or retractable compartment 30b.

In addition, as another alternative, the roof frames 42 of any retractable tent compartments 30a and 30b used with the inventive covering system 500 can be removed such that the upper ends of the outer wall frames 40 of the tent compartments 30a and 30b can be connected directly to the outer ends or outer end portions of the left and right cover support frames 504 and 506 and/or linking members 525 so that, e.g., the removable covering of the inventive covering system 500 will also serve as the upper covering for the tent compartments 30a and 30b.

The inventive covering system 500 also preferably comprises: (i) each of the sloped upper frame elements 514 of each of the left and the right cover support frames 504 and 506 installed in each of the first, the second, and/or any succeeding lateral channels having a U-shaped bracket 526 on an upper end of the sloped upper frame element 514; (ii) a longitudinally extending left elongate support member 528 received in the U-shaped brackets 526 on the upper ends of the sloped upper frame elements 514 of the left cover support frames 504; (iii) a longitudinally extending right elongate support member 530 received in the U-shaped brackets 526 on the upper ends of the sloped upper frame elements 514 of the right cover support frames 506; (iv) a second set of shorter left and right cover support frames 532 and 534 over a forward portion of the cargo housing 10 which are different from the first set of left and right cover support frames 504 and 506 in that the lower frame element 536 of each of the shorter cover support frames 532 and 534 is attached substantially at the outer end of a sloped upper frame element 538 of the support frame 532 or 534; and (v) another folding cover support frame 540 which is received and held in a longitudinally extending channel 542 attached to the roof 18 over an angled, aerodynamic forward portion 544 of the cargo housing 10 (if present).

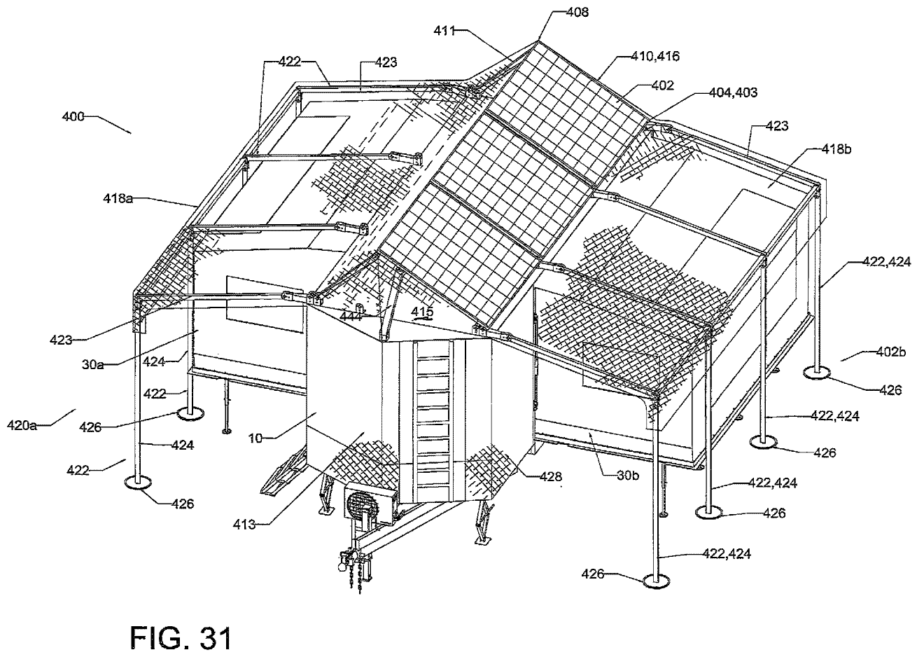

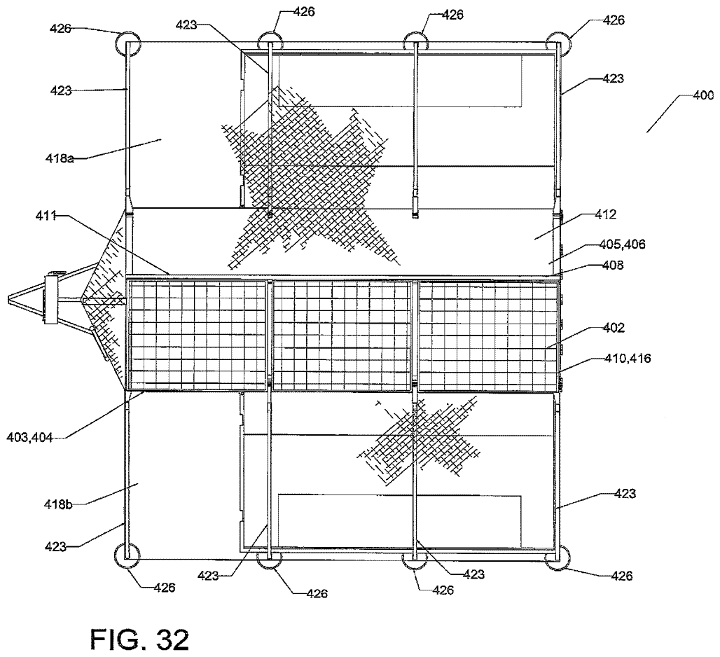

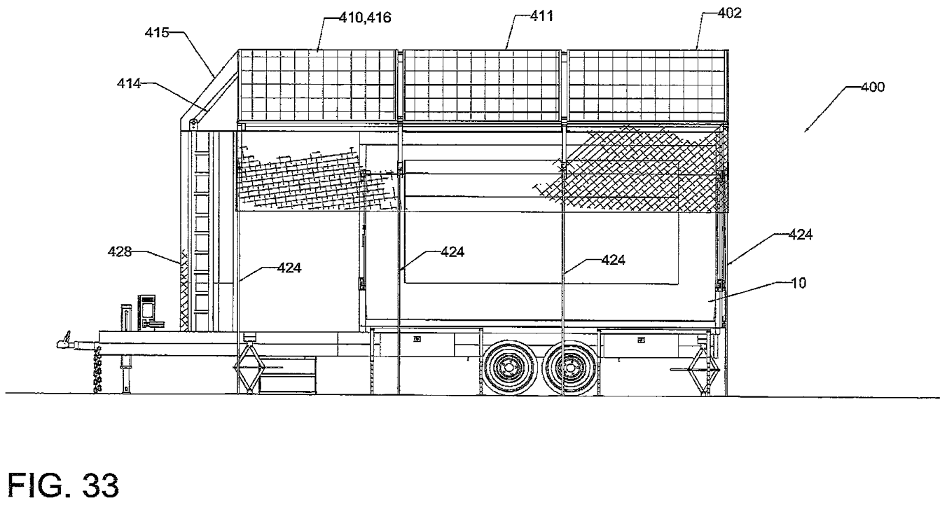

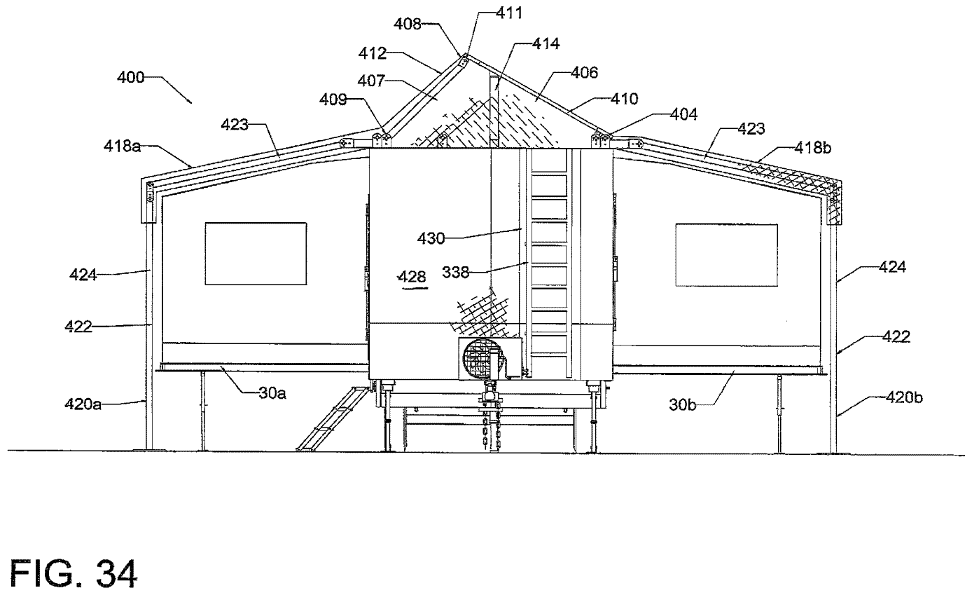

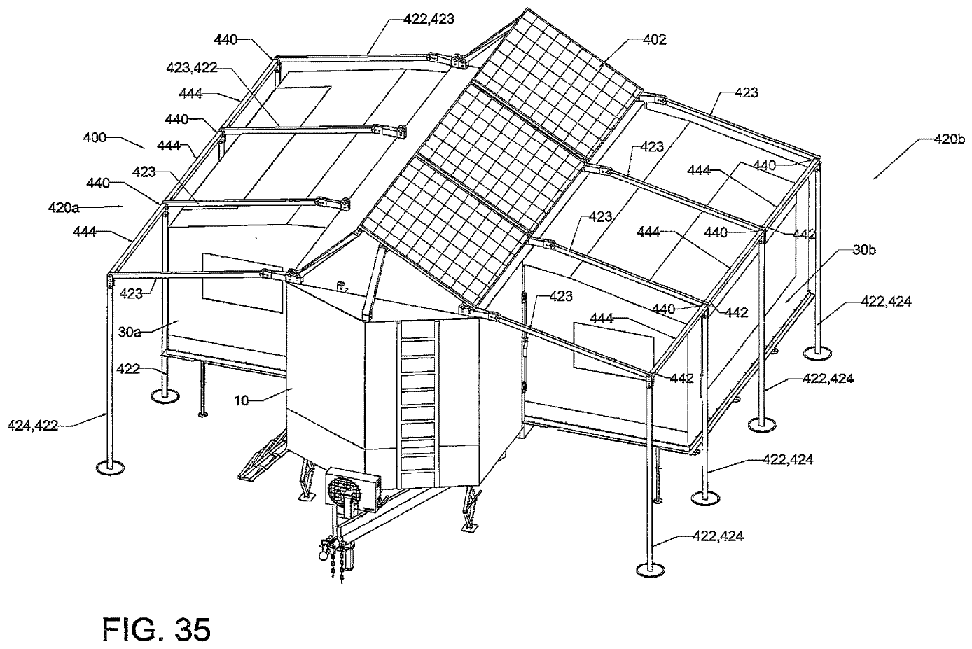

Another embodiment 400 of the covering system provided by the present invention is illustrated in FIGS. 31-35. By way of example, but not by way of limitation, the inventive covering system 400 is well suited for use on trailers 2 or trucks 200 having solar panel structures 402 installed on the cargo housings 10 thereof. The solar panel structure 402 will preferably extend longitudinally along all or substantially all of the length of the roof 18 of the cargo housing 10.

The outer frame of the solar panel structure 402 will preferably have a longitudinally extending outer edge 404 which is pivotably secured along an outer edge 403 of the roof 18 of the cargo housing 10 so that the solar panel structure 402 can be pivoted from (i) a flat position on the roof 18 to (ii) an upwardly angled operating position in which the opposite longitudinally extending outer edge 411 of the frame of the solar panel structure 402 is raised. The solar panel structure 402 is supported in the upwardly angled operating position by a plurality of pivotable and/or removable support arms 407 which extend upwardly at an angle from the opposite outer edge 409 of the roof 18 of the cargo housing 10 to the raised outer longitudinal edge 411 of the frame of the solar panel structure 402.

To accommodate the upwardly angled operating position of the solar panel structure 402, and/or for purposes of appearance, water runoff, etc., the inventive covering system 400 includes a removable covering 405 having a roof 406 which is positioned over the cargo housing 10 and which comprises: (i) a longitudinally extending upper ridge 408, (ii) a first side 410 of the roof 406 which extends outwardly from the upper ridge 408 at a downward angle, and (iii) a second side 412 of the roof 406, opposite the first side 410, which extends outwardly from the upper ridge 408 at a downward angle.

The roof 406 of the removable covering 405 is supported over the roof 18 of the cargo housing 10 by the outer frame of the solar panel structure 402 and the support arms 407 which hold the solar panel structure 402 in its upwardly angled operating position. If the cargo housing 10 has an angled front end 413 for reduced wind resistance, the inventive covering system 400 can further comprise: (i) an additional solar panel support arm 414 which extends upwardly at a rearward angle from the angled forward portion of the roof 18 of the cargo housing 10 to the forward end of the solar panel structure 402 and (ii) a downwardly angled forward extension 415 of the roof 406 of the removable covering 405 which covers the angled front end 413 of the cargo housing 10 and the rearwardly angled solar panel support arm 414.

At least most of a total area of the first side 410 of the roof 406 of the removable covering 405 is an open area 416 which is positioned over the solar panel structure 402 to expose the solar panel structure 402 to sunlight when the solar panel structure 402 is oriented in its upwardly angled operating position.

Although the solar panel structure 406 and the corresponding open area 416 in the roof 406 of the removable covering 405 are shown as extending along substantially the entire longitudinal length of the roof 18 of the cargo housing 10 of the trailer 2 or truck 200, it will be understood that a shorter and/or narrower (or wider) solar panel structure 402, along with a correspondingly shorter and/or narrower (or wider) open area 416 in the roof 406 of the removable covering 405, can alternatively be used. In addition, if the cargo housing 10 does not include a solar panel structure 402 on the roof 18 thereof, the open area 416 in the roof 406 of the removable covering 405 can be eliminated, in which case, each side 410 and 412 of the roof 406 of the removeable covering 405 can be supported, e.g., by an upwardly angled support frame and/or a plurality of upwardly angled support arms.

The removable covering 405 further comprises a side canopy 418a and/or a side canopy 418b for covering preferably all or at least most of the top of each of the one or more retractable compartments or platforms 30a and/or 30b which are included in the cargo housing 10 of the trailer 2 or truck 200. Each canopy 418a and 418b preferably extends from a lower side edge of the roof 406 of the removable covering 405 and is preferably supported over and spaced above the retractable compartment or platform 30a or 30b by a set 420a or 420b of removable canopy supports 422.

Each removable canopy support 422 preferably comprises (i) an outwardly extending first elongate support element 423 which extends outwardly from the roof 18 of the cargo housing 10, or from an upper portion of the side of the cargo housing 10, (ii) a downwardly extending second elongate support element 424 that extends downwardly from the distal/outer end of the first elongate support element 423, and (iii) a foot pad 426 which is provided on the lower end of the downwardly extending elongate support element 424. The outwardly extending first elongate support elements 423 slope downwardly as they extend outwardly to facilitate the flow rainwater off of the side canopies 418a and 418b.

In the embodiment 400 depicted in FIGS. 31-35, the inventive covering system 400 is used on a cargo housing 10 having both a retractable left-side compartment or platform 30a and a retractable right-side compartment or platform 30b so that: (i) a first set 420a of removable canopy supports 422 is provided on the left side of the cargo housing 10; (ii) a second set 420b of removable canopy supports 422 is provided on the right side of the cargo housing 10; (iii) two or more (preferably three) of the outwardly extending elongate support elements 423 of the canopy supports 422 of the first set 420a preferably extend laterally outward above and beyond the retractable left-side compartment or platform 30a; (iv) two or more (preferably three) of the outwardly extending elongate support elements 423 of the canopy supports 422 of the second set 420b preferably extend laterally outward above and beyond the retractable right-side compartment or platform 30; (v) a left-side canopy 418a of the removable covering 405 is positioned on the outwardly extending elongate support elements 423 of the canopy supports 422 of the first set 420a so that the canopy 418a extends over and is spaced above the top of the retractable left-side compartment or platform 30a of the cargo housing 10; and (vi) a right-side canopy 418b of the removable covering 405 is positioned on the outwardly extending first elongate support elements 423 of the canopy supports 422 of second set 420b so that the canopy 418b extends over and is spaced above the top of the retractable right-side compartment or platform 30b of the cargo housing 10.

In addition, each of the left set 420a and the right set 420b of removable canopy supports 422 of the inventive covering system 400 preferably also comprises: (i) opposing attachment brackets 440 and 442 which extend laterally toward each other from the distal ends of the outwardly extending first elongate support elements 423 of each adjacent pair of the canopy supports 422 and (ii) removable linking support elements 444 which extend between the distal ends of the outwardly extending support elements 423 of each adjacent pair of canopy supports 422 and are snapped into, pinned into, or otherwise connected to the opposing attachment brackets 440 and 442 of each adjacent pair of the canopy supports 422.

As with the removable covering 308 described above, the removable covering 405 of the inventive covering system 400 can be formed of any material suitable for the conditions to which the inventive covering 400 will be subjected and can also be of any pattern, design, appearance, or functional nature desired. Examples of materials preferred for forming the removable covering 405 include, but are not limited to: canvas; vinyl fabric; PVC-coated mesh; laminated fabric; extruded film; 500D nylon; 1000D nylon; other grades of nylon; anti-microbial fabric; flame retardant fabric; or infrared fabric.

The removable covering 405 of the inventive covering system 400 also preferably includes an apron 428 which extends downwardly from the roof 406 of the removable covering 405 to wrap around and at least partially screen a forward or rearward longitudinal end portion of the cargo housing 10. If the forward or rearward end portion of the cargo housing 10 includes a ladder 338 and/or includes a door 134 for the entering and exiting the cargo housing 10, the apron 428 of the removable covering 405 will preferably include (i) a ladder opening 430 in which the ladder 338 is positioned for access to the ladder 338 and/or (ii) a door opening in which the door 134 is positioned for access to the door 134.

As will be apparent, all of the components of each of the inventive covering systems 300, 350, and 400 which do not remain in a lowered position on the roof 18 of the cargo housing 10 of the trailer 2 or truck 200 when not in use will preferably be foldable, separatable, and/or telescopingly retractable as needed for stowing and transporting in either (i) the cargo compartment 14 of the cargo housing 10 or (ii) the storage compartments 138 below the cargo bed 16.

Thus, the present invention is well adapted to carry out the objectives and attain the ends and advantages mentioned above as well as those inherent therein. While presently preferred embodiments have been described for purposes of this disclosure, numerous changes and modifications will be apparent to those in the art. Such changes and modifications are encompassed within the invention as defined by the claims.

What is claimed is:

1. A trailer or truck comprising:
a cargo housing having a roof on top of the cargo housing and a housing compartment within the cargo housing;
a plurality of first support structures which extend upwardly from the roof of the cargo housing;
a plurality of second support structures which (i) extend upwardly from the roof of the cargo housing, (ii) are shorter than the first support structures, and (iii) are each positioned between one of the first support structures and an outer perimeter of the roof of the cargo housing or are positioned on the outer perimeter of the roof of the cargo housing;
a plurality of outwardly extending covering support elements, each of which (i) extends outwardly from an upper end or upper portion of one of the first support structures and (ii) slopes downwardly as it extends outwardly;
at least most of the outwardly extending covering support elements being supported by one of the second support structures; and
a removable covering which is positioned over the first support structures, the second support structures, and the outwardly extending covering support elements and covers at least most of the roof of the cargo housing.

2. The trailer or truck of claim 1 further comprising each of the first support structures comprising a segment of a post, conduit, U-shaped channel member, pipe, bar, pole, or rod.

3. The trailer or truck of claim 1 further comprising:
the outwardly extending covering support elements having distal ends and
for each adjacent pair of the outwardly extending covering support elements, a linking support element being removably connected between the distal ends of the adjacent outwardly extending covering support elements.

4. The trailer or truck of claim 1 further comprising:
at least most of the outwardly extending covering support elements being upper frame elements for a plurality of outwardly extending covering support frames and
at least most of the outwardly extending covering support frames further comprising a lower frame element which extends substantially horizontally between (i) an outer portion of the upper frame element of the outwardly extending covering support frame and (ii) a lower end of one of the second support structures which supports the upper frame element of the outwardly extending covering support frame.

5. The trailer or truck of claim 1 further comprising each of the first support structures and each of the second support structures being (i) downwardly pivotable to a horizontal position on the roof of the cargo housing and/or (ii) removable from the roof of the cargo housing.

6. The trailer or truck of claim 1 further comprising a plurality of lateral channels on the roof of the cargo housing and at least most of the first support structures and at least most of the second support structures having lower ends which are received and held in the lateral channels.

7. The trailer or truck of claim 1 further comprising:
one of the first support structures being a longitudinally forward-most one of the first support structures;
another of the first support structures being a longitudinally rearward-most one of the first support structures; and
another of the first support structures being a taller support structure which is positioned between and is taller than the forward-most one of the first support structures and the rearward-most one of the first support structures.

8. The trailer or truck of claim 1 further comprising the removable covering being formed of canvas, vinyl fabric, PVC-coated mesh, laminated fabric, extruded film, 500D nylon, 1000D nylon, anti-microbial fabric, flame retardant fabric, or infrared fabric.

9. The trailer or truck of claim 1 further comprising:
one or more retractable platforms or retractable compartments, each of the one or more retractable platforms or retractable compartments being extendable from the cargo housing to a deployed position for use and being retractable to a retracted position for transporting the trailer or truck and
for each of the one or more retractable platforms or retractable compartments, the covering being positioned over at least most of a top of the retractable platform or retractable compartment when (i) the retractable platform or retractable compartment is in its deployed position and (ii) the covering is positioned over the first and the second support structures and the outwardly extending covering support elements.

10. The trailer or truck of claim 9 further comprising, for each of the one or more retractable platforms or retractable compartments, the retractable platform or retractable compartment having a floor which pivots upwardly to cover a side opening of the cargo housing when the retractable platform or retractable compartment is retracted to its retracted position.

11. The trailer or truck of claim 10 further comprising, for each of the one or more retractable platforms or retractable compartments, at least one outrigger for supporting the floor of the retractable platform or retractable compartment when the retractable platform or retractable compartment is in its deployed position, the outrigger comprising:
a pivot arm which is pivotable from a stowed position of the pivot arm beneath the bottom bed of the cargo housing to a deployed position of the pivot arm extending outwardly from the cargo housing and
a support element which is pivotably attached to the pivot arm, the support element being pivotable from (i) a lowered position which permits the pivot arm to be pivoted to the stowed position of the pivot arm beneath the bottom bed of the cargo housing to (ii) a raised position on top of the pivot arm in which the floor of the retractable platform or retractable compartment rests on the support element when the retractable platform or retractable compartment is in its deployed position and the pivot arm of the outrigger is in the deployed position of the pivot arm.

12. The trailer or truck of claim 10 further comprising each of the one or more retractable platforms or retractable compartments being a retractable tent compartment comprising a collapsible tent which extends upwardly from the floor of the retractable tent compartment when the retractable tent compartment is in its deployed position.

13. The trailer or truck of claim 9 further comprising:
a first one of the one or more retractable platforms or retractable compartments retractably extending from a left lateral side of the cargo housing and
a second one of the one or more retractable platforms or retractable compartments retractably extending from a right lateral side of the cargo housing.

14. A trailer or truck comprising:
a cargo housing having a roof on top of the cargo housing and a housing compartment within the cargo housing;
a left retractable platform or retractable compartment which is extendable from a left lateral side of the cargo housing to a deployed position for use and is retractable to a retracted position for transporting the trailer or truck;
a right retractable platform or retractable compartment which is extendable from a right lateral side of the cargo housing to a deployed position for use and is retractable to a retracted position for transporting the trailer or truck;
a plurality of first support structures which extend upwardly from the roof of the cargo housing;
a plurality of second support structures which (i) extend upwardly from the roof of the cargo housing, (ii) are shorter than the first support structures, and (iii) are each positioned between one of the first support structures and an outer perimeter of the roof of the cargo housing or are positioned on the outer perimeter of the roof of the cargo housing;
a plurality of outwardly extending covering support frames, each of the covering support frames having an upper frame element which (i) extends outwardly from an upper end or upper portion of one of the first support structures and (ii) slopes downwardly as it extends outwardly;
the upper frame element of at least most of the outwardly extending covering support frames being supported by one of the second support structures;
a removable covering which is positioned over the first support structures and the outwardly extending covering support frames; and
when the left retractable platform or retractable compartment and the right retractable platform or retractable compartment are in their deployed positions and the removable covering is positioned over the first support structures and the outwardly extending covering support frames, the removable covering extends over at least most of the roof of the cargo housing, at least most of a top of the left retractable platform or retractable compartment, and at least most of a top of the right retractable platform or retractable compartment.

15. The trailer or truck of claim 14 further comprising:
the outwardly extending covering support frames having distal ends and
for each adjacent pair of the outwardly extending covering support frames, a linking support element being removably connected between the distal ends of the adjacent outwardly extending covering support frames.

16. The trailer or truck of claim 14 further comprising, for at least most of the outwardly extending covering support frames, a lower frame element which extends horizontally from an outer portion of the upper frame element of the outwardly extending covering support frame back toward one of the second support structures which supports the upper frame element of the outwardly extending covering support frame.

17. The trailer or truck of claim 14 further comprising each of the first support structures and each of the second support structures being (i) downwardly pivotable to a horizontal position on the roof of the cargo housing and/or (ii) removable from the roof of the cargo housing.

18. The trailer or truck of claim 14 further comprising a plurality of lateral channels on the roof of the cargo housing and at least most of the first support structures and at least most of the second support structures having lower ends which are received and held in the lateral channels.

19. The trailer or truck of claim 14 further comprising:
the left retractable platform or retractable compartment having a floor which pivots upwardly to cover a side opening in the left lateral side of the cargo housing when the left retractable platform or retractable compartment is retracted to its retracted position and
the right retractable platform or retractable compartment having a floor which pivots upwardly to cover a side opening in the right lateral side of the cargo housing when the right retractable platform or retractable compartment is retracted to its retracted position.

20. The trailer or truck of claim 19 further comprising:
one or more left outriggers for supporting the floor of the left retractable platform or retractable compartment;
one or more right outriggers for supporting the floor of the right retractable platform or retractable compartment;
each of the one or more left outriggers comprising
a pivot arm which is pivotable from a stowed position of the pivot arm of the left outrigger beneath a bottom bed of the cargo housing to a deployed position of the pivot arm of the left outrigger extending outwardly from the cargo housing and
a support element which is pivotably attached to the pivot arm of the left outrigger, the support element of the left outrigger being pivotable from (i) a lowered position which permits the pivot arm of the left outrigger to be pivoted to the stowed position of the pivot arm of the left outrigger beneath the bottom bed of the cargo housing to (ii) a raised position on top of the pivot arm of the left outrigger in which the floor of the left retractable platform or retractable compartment rests on the support element of the left outrigger when the left retractable platform or retractable compartment is in its deployed position and the pivot arm of the left outrigger is in the deployed position of the pivot arm of the left outrigger; and
each of the one or more right outriggers comprising
a pivot arm which is pivotable from a stowed position of the pivot arm of the right outrigger beneath the bottom bed of the cargo housing to a deployed position of the pivot arm of the right outrigger extending outwardly from the cargo housing and
a support element which is pivotably attached to the pivot arm of the right outrigger, the support element of the right outrigger being pivotable from (i) a lowered position which permits the pivot arm of the right outrigger to be pivoted to the stowed position of the pivot arm of the right outrigger beneath the bottom bed of the cargo housing to (ii) a raised position on top of the pivot arm of the right outrigger in which the floor of the right retractable platform or retractable compartment rests on the support element of the right outrigger when the right retractable platform or retractable compartment is in its deployed position and the pivot arm of the right outrigger is in the deployed position of the pivot arm of the right outrigger.

21. A trailer or truck comprising:
a cargo housing having a roof on top of the cargo housing and a housing compartment within the cargo housing;
a plurality of lateral channels positioned on the roof of the cargo housing which are spaced longitudinally apart;
a set of cover support frames in which each of the cover support frames in the set of cover support frames comprises:
a first upwardly extending support structure having a lower end which is removably received and held in a supporting one of the lateral channels,
a sloped upper frame element which extends laterally outward, at a downward inclination, from an upper end or upper portion of the first upwardly extending support structure, and
a second upwardly extending support structure having an upper end which is attached at a mid-portion location of the sloped upper frame element and having a lower end which is removably received and held in the supporting one of the lateral channels, the first upwardly extending support structure being taller than the second upwardly extending support structure; and
a removable covering which is positioned on, and supported over at least a portion of the roof of the cargo housing by, the set of cover support frames.

22. The trailer or truck of claim 21 further comprising each of the lateral channels being a U-shaped channel having an open top.

23. The trailer or truck of claim 21 further comprising each of the cover support frames of the set of cover support frames being a folding frame comprising:
the upper end of the first upwardly extending support structure of the cover support frame being pivotably attached to the sloped upper frame element of the cover support frame;
the first upwardly extending support structure of the cover support frame having a U-shaped channel in which the sloped upper frame element of the cover support frame is received when the first upwardly extending support structure is pivoted to a folded position;
the upper end of the second upwardly extending support structure of the cover support frame being pivotably attached to the sloped upper frame element of the cover support frame at the mid-portion location; and
the second upwardly extending support structure of the cover support frame having a U-shaped channel in which the sloped upper frame element of the cover support frame is received when the second upwardly extending support structure is pivoted to a folded position.

24. The trailer or truck of claim 21 further comprising:
the sloped upper frame elements having distal ends and
for each adjacent pair of the cover support frames of the set of cover support frames, a linking support element being removably connected between the distal ends of the sloped upper frame elements of the adjacent cover support frames.

25. The trailer or truck of claim 21 further comprising each of the cover support frames of the set of cover support frames having a lower frame element which (i) has an outer end which is attached to the sloped upper frame element of the cover support frame at an outer location which is spaced outwardly from the mid-portion location at which the second upwardly extending support structure is attached to the sloped upper frame element and (ii) extends substantially horizontally from the outer location of the sloped upper frame element back toward the lower end of the second upwardly extending support structure.

26. The trailer or truck of claim 25 further comprising, for each of the cover support frames of the set of cover support frames, the sloped upper frame element of the cover support frame having a distal segment which extends outwardly, at a downward inclination, beyond the outer location at which the outer end of the lower frame element is attached to the sloped upper frame element.

27. The trailer or truck of claim 26 further comprising:
the set of cover support frames being a first set of cover support frames and
the trailer or truck further including a second set of cover support frames which are different from the first set of cover support frames in that each of the cover support frames of the second set comprises an outer end of a lower frame element being attached substantially at an outer end of a sloped upper frame element.

28. The trailer or truck of claim 25 further comprising each of the cover support frames of the set of cover support frames comprising:
the upper end of the first upwardly extending support structure of the cover support frame being pivotably attached to the sloped upper frame element of the cover support frame;
the first upwardly extending support structure of the cover support frame having a U-shaped channel in which the sloped upper frame element of the cover support frame is received when the first upwardly extending support structure is pivoted to a folded position;
the upper end of the second upwardly extending support structure of the cover support frame being pivotably attached to the sloped upper frame element of the cover support frame;
the second upwardly extending support structure of the cover support frame having a U-shaped channel in which the sloped upper frame element of the cover support frame is received when the second upwardly extending support structure is pivoted to a folded position;
the outer end of the lower frame element of the cover support frame being pivotably attached to the sloped upper frame element of the cover support frame; and
the lower frame element of the cover support frame having a U-shaped channel in which the sloped upper frame element of the cover support frame is received when the lower frame element is pivoted to a folded position.

29. The trailer or truck of claim 21 further comprising each of the sloped upper frame elements of the cover support frames of the set of cover support frames having a U-shaped bracket on an upper end of the sloped upper frame element which receives a longitudinally extending elongate member.

30. The trailer or truck of claim 21 further comprising:
one or more retractable platforms or retractable compartments, each of the one or more retractable platforms or retractable compartments being extendable from the cargo housing to a deployed position for use and being retractable to a retracted position for transporting the trailer or truck and
for each of the one or more retractable platforms or retractable compartments, the covering being positioned over at least most of a top of the retractable platform or retractable compartment when (i) the retractable platform or retractable compartment is in its deployed position and (ii) the removable covering is positioned on at least the cover support frames of the set of cover support frames.

31. The trailer or truck of claim 30 further comprising, for each of the one or more retractable platforms or retractable compartments, the retractable platform or retractable compartment having a floor which pivots upwardly to cover a side opening of the cargo housing when the retractable platform or retractable compartment is retracted to its retracted position.

32. The trailer or truck of claim 31 further comprising, for each of the one or more retractable platforms or retractable compartments, at least one outrigger for supporting the floor of the retractable platform or retractable compartment when the retractable platform or retractable compartment is in its deployed position, the outrigger comprising:
a pivot arm which is pivotable from a stowed position of the pivot arm beneath the bottom bed of the cargo housing to a deployed position of the pivot arm extending outwardly from the cargo housing and
a support element which is pivotably attached to the pivot arm, the support element being pivotable from (i) a lowered position which permits the pivot arm to be pivoted to the stowed position of the pivot arm beneath the bottom bed of the cargo housing to (ii) a raised position on top of the pivot arm in which the floor of the retractable platform or retractable compartment rests on the support element when the retractable platform or retractable compartment is in its deployed position and the pivot arm of the outrigger is in the deployed position of the pivot arm.

33. A trailer or truck comprising:
a cargo housing having a roof on top of the cargo housing and a housing compartment within the cargo housing;
a first lateral channel on the roof of the cargo housing;
a second lateral channel on the roof of the cargo housing, the second lateral channel being spaced longitudinally apart from the first lateral channel;
the first lateral channel and the second lateral channel each having a left cover support frame and a right cover support frame installed therein;
each of the left and the right cover support frames installed in each of the first and the second lateral channels comprising
a first upwardly extending support structure having a lower end which is removably received and held in the lateral channel,
a sloped upper frame element which extends laterally outward, at a downward inclination, from an upper end or upper portion of the first upwardly extending support structure, and
a second upwardly extending support structure having an upper end which is attached at a mid-portion location of the sloped upper frame element and having a lower end which is removably received and held in the lateral channel, the first upwardly extending support structure being taller than the second upwardly extending support structure;
the sloped upper frame elements of the left cover support frames installed in the first and the second lateral channels extending laterally outward over a left side of the roof of the cargo housing;
the sloped upper frame elements of the right cover support frames installed in the first and the second lateral channels extending laterally outward over a right side of the roof of the cargo housing; and
a removable covering which is positioned on, and supported over at least a portion of the roof of the cargo housing by at least (i) the left and the right cover support frames installed in the first lateral channel and (ii) the left and the right cover support frames installed in the second lateral channel.

34. The trailer or truck of claim 33 further comprising each of the left and the right cover support frames installed in each of the first and the second lateral channels having a lower frame element which (i) has an outer end which is attached to the sloped upper frame element of the cover support frame at an outer location which is spaced outwardly from the mid-portion location at which the second upwardly extending support structure is attached to the sloped upper frame element and (ii) extends substantially horizontally from the outer location of the sloped upper frame element back toward the lower end of the second upwardly extending support structure.

35. The trailer or truck of claim 34 further comprising each of the left and the right cover support frames installed in each of the first and the second lateral channels comprising:
the upper end of the first upwardly extending support structure of the cover support frame being pivotably attached to the sloped upper frame element of the cover support frame;
the first upwardly extending support structure of the cover support frame having a U-shaped channel in which the sloped upper frame element of the cover support frame is received when the first upwardly extending support structure is pivoted to a folded position;
the upper end of the second upwardly extending support structure of the cover support frame being pivotably attached to the sloped upper frame element of the cover support frame at the mid-portion location;
the second upwardly extending support structure of the cover support frame having a U-shaped channel in which the sloped upper frame element of the cover support frame is received when the second upwardly extending support structure is pivoted to a folded position;
the outer end of the lower frame element of the cover support frame being pivotably attached to the sloped upper frame element of the cover support frame; and
the lower frame element of the cover support frame having a U-shaped channel in which the sloped upper frame element of the cover support frame is received when the lower frame element is pivoted to a folded position.

36. The trailer or truck of claim 33 further comprising:
each of the sloped upper frame elements of each of the left and the right cover support frames installed in each of the first and the second lateral channels having a U-shaped bracket on an upper end of the sloped upper frame element;
a longitudinally extending left elongate member received in the U-shaped brackets on the upper ends of the sloped upper frame elements of the left cover support frames installed in the first and the second lateral channels; and
a longitudinally extending right elongate member received in the U-shaped brackets on the upper ends of the sloped upper frame elements of the right cover support frames installed in the first and the second lateral channels.

37. The trailer or truck of claim 33 further comprising:
a left retractable platform or retractable compartment which is extendable from a left lateral side of the cargo housing to a deployed position for use and is retractable to a retracted position for transporting the trailer or truck;
the left cover support frames installed in the first and the second lateral channels extending outwardly over the left retractable platform or retractable compartment when the left retractable platform or retractable compartment is in its deployed position;
a right retractable platform or retractable compartment which is extendable from a right lateral side of the cargo housing to a deployed position for use and is retractable to a retracted position for transporting the trailer or truck; and
the right cover support frames installed in the first and the second lateral channels extending outwardly over the right retractable platform or retractable compartment when the right retractable platform or retractable compartment is in its deployed position.

38. A trailer or truck comprising:
a cargo housing having a roof on top of the cargo housing and a housing compartment within the cargo housing;
a retractable platform or retractable compartment which is extendable from a lateral side of the cargo housing to a deployed position for use and is retractable to a retracted position for transporting the trailer or truck;
a longitudinally extending solar panel structure that is pivotably secured on the roof of the cargo housing for pivoting the solar panel structure upwardly on the roof of the cargo housing to an upwardly angled operating position;
a set of removable canopy supports on the lateral side of the cargo housing, each of the canopy supports comprising (i) a first elongate support element that extends outwardly from the roof of the cargo housing, or from an upper portion of the lateral side of the cargo housing, and (ii) a second elongate support element that extends downwardly from a distal end or end portion of the first elongate support element; and
a removable covering comprising
a roof having (i) a longitudinally extending upper ridge, (ii) a first side which extends outwardly from the upper ridge at a downward angle, at least most of a total area of the first side of the roof of the removable covering being an open area which is positioned over the solar panel structure to expose the solar panel structure to sunlight when the solar panel structure is oriented in its angled operating position and (iii) a second side, opposite the first side of the roof of the removable covering, which extends outwardly from the upper ridge at a downward angle and
a canopy which extends from a lower side edge of the roof of the removable covering over the first elongate support elements of the canopy supports so that the canopy is positioned over at least most of a top of the retractable platform or retractable compartment.

39. The trailer or truck of claim 38 further comprising the removable covering including an apron which extends downwardly from the roof of the removable covering to at least partially screen a forward or rearward longitudinal end portion of the cargo housing.

40. The trailer or truck of claim 39 further comprising:
the forward or rearward longitudinal end portion of the cargo housing having (i) a ladder attached to the forward or rearward longitudinal end portion of the cargo housing and (ii) a door for entering and exiting the housing compartment;
the apron of the removable covering having a ladder opening in which the ladder is positioned for access to the ladder; and
the apron of the removable covering having a door opening in which the door is positioned for access to the door.

41. The trailer or truck of claim 38 further comprising:
the retractable platform or retractable compartment being a first retractable platform or retractable compartment and the lateral side of the cargo housing being a left lateral side;
a second retractable platform or retractable compartment which is extendable from a right lateral side of the cargo housing to a deployed position for use and is retractable to a retracted position for transporting the trailer or truck;
the set of removable canopy supports being a first set of canopy supports;
a second set of removable canopy supports on the right lateral side of the cargo housing, each of the removable canopy supports of the second set of removable canopy supports comprising (i) a first elongate support element that extends outwardly from the roof of the cargo housing, or from an upper portion of the right lateral side, and (ii) a second elongate support element that extends downwardly from a distal end or end portion of the first elongate support element of the removable canopy support of the second set of removable canopy supports;
the canopy of the removable covering being a first canopy and the lower side edge of the roof of the removable covering being a lower left side edge of the roof of the removable covering; and
the removable covering further comprising a second canopy which extends from a lower right side edge of the roof of the removable covering over the first elongate support elements of the removable canopy supports of the second set of removable canopy supports so that the second canopy is positioned over at least most of a top of the second retractable platform or retractable compartment.

42. The trailer or truck of claim 38 further comprising, for each adjacent pair of the canopy supports of the set of removable canopy supports, a linking support element being removably connected between the distal ends of the first elongate support elements of the adjacent pair of the canopy supports.

43. The trailer or truck of claim 38 further comprising:
the retractable platform or retractable compartment having a floor which pivots upwardly to cover a side opening of the cargo housing when the retractable platform or retractable compartment is retracted to its retracted position and
the trailer or truck further comprising at least one outrigger for supporting the floor of the retractable platform or retractable compartment when the retractable platform or retractable compartment is in its deployed position, the outrigger comprising
a pivot arm which is pivotable from a stowed position of the pivot arm beneath a bottom bed of the cargo housing to a deployed position of the pivot arm extending outwardly from the cargo housing and
a support element which is pivotably attached to the pivot arm, the support element being pivotable from (i) a lowered position which permits the pivot arm to be pivoted to the stowed position of the pivot arm beneath the bottom bed of the cargo housing to (ii) a raised position on top of the pivot arm, the floor of the retractable platform or retractable compartment resting on the support element when the retractable platform or retractable compartment is in its deployed position, the pivot arm of the outrigger is in the deployed position of the pivot arm, and the support element is in its raised position.

44. A trailer or truck comprising:
a cargo housing having a roof on top of the cargo housing, a housing compartment within the cargo housing, and a bottom bed;
a retractable platform or retractable compartment which is extendable from a lateral side of the cargo housing to a deployed position for use and is retractable to a retracted position for transporting the trailer or truck, the retractable platform or retractable compartment having a floor which pivots upwardly to cover a side opening of the cargo housing when the retractable platform or retractable compartment is retracted to its retracted position; and
at least one outrigger for supporting the floor of the retractable platform or retractable compartment when the retractable platform or retractable compartment is in its deployed position, the outrigger comprising
a pivot arm which is pivotable from a stowed position of the pivot arm beneath the bottom bed of the cargo housing to a deployed position of the pivot arm extending outwardly from the cargo housing;
a support element which is positionable on top of the pivot arm in a supporting position of the support element; and
when (i) the pivot arm of the outrigger is in the deployed position of the pivot arm, (ii) the support element is positioned on top of the pivot arm in the supporting position of the support element, and (iii) the retractable platform or retractable compartment is in its deployed position, the floor of the retractable platform or retractable compartment will rest on the support element.

45. The trailer or truck of claim further comprising:
the support element being pivotably attached to the pivot arm and
the support element being upwardly pivotable from (i) a lowered position which permits the pivot arm to be pivoted to the stowed position of the pivot arm beneath the bottom bed of the cargo housing to (ii) the supporting position of the support element on top of the pivot arm.

46. The trailer or truck of claim 45 further comprising the outrigger having a height adjustable leg which is removably insertable into a distal end of the pivot arm for stowing and transport and is attachable to the distal end of the pivot arm in a downwardly extending position to support the distal end of the pivot arm above a ground surface when the pivot arm is in the deployed position of the pivot arm.
